(19) United States
(12) Patent Application Publication
(10) Pub. No.: US 2024/0343550 A1
(43) Pub. Date: Oct. 17, 2024

(54) ARTICLES INCLUDING A MICROSTRUCTURED CURVED SURFACE AND METHODS OF MAKING SAME

(71) Applicant: 3M INNOVATIVE PROPERTIES COMPANY, St. Paul, MN (US)

(72) Inventors: Ta-Hua Yu, Woodbury, MN (US); Olester Benson, Woodbury, MN (US); Timothy J. Hebrink, Scandia, MN (US); Jodi L. Connell, St. Paul, MN (US); Bruce R. Broyles, Oakdale, MN (US); Ming-Lai Lai, Afton, MN (US); Raymond P. Johnston, Lake Elmo, MN (US)

(21) Appl. No.: 18/293,452

(22) PCT Filed: Sep. 13, 2022
(86) PCT No.: PCT/IB2022/058618

§ 371 Date: Jan. 30, 2024

Related U.S. Application Data
(60) Provisional application No. 63/243,855, filed on Sep. 14, 2021.
(60) Provisional application No. 63/402,633, filed on Aug. 31, 2022.

(51) Int. Cl. B81B 1/00; A61C 7/08; A63B 71/08; B29C 51/02; B29C 59/02; B29L 31/00

(52) U.S. Cl. CPC B81B 1/006; A61C 7/08; A63B 71/085; B29C 51/02; B29C 59/022; A63B 2209/00; B29C 2059/023; B29L 2031/753; B29L 2031/756

(57) ABSTRACT

The present disclosure provides a microstructured article (830, 930) including a thermoplastic polymer shaped to have a curve. At least a portion of the curve includes a microstructured surface (1010B, 10, 1110A, 200, 300, 400, 500, 600, 810, 840, 910, 940) of utilitarian discontinuities and the microstructured surface (101B, 10, 1110A, 200, 300, 400, 500, 600, 810, 840, 910, 940) includes peak structures and adjacent valleys (810, 910). The peak structures and the curve are formed of a single piece of the thermoplastic polymer. A method of making the microstructured articles is also provided including a) obtaining a tool (820, 920) shaped to include at least one of a protrusion or a concavity; b) disposing a microstructured film (800A, 800C, 900) on at least a portion of the tool (820, 920) including the protrusion and/or the concavity; and c) thermoforming a single piece of thermoplastic polymer onto the tool (820, 920) to form a microstructured article (830, 930) shaped to include a curve. The curve is an inverse of the protrusion or the concavity of the tool (820, 920).

### FIELD

The present disclosure generally relates to microstructured articles and method of making microstructured articles.

### BACKGROUND

Certain articles with microstructured surfaces have been demonstrated to provide a reduction of microorganism (e.g., bacteria) after cleaning. It can be challenging, however, to achieve strong interfacial adhesion between microstructures and other portions of the article.

### SUMMARY

In a first aspect, a microstructured article is provided. The microstructured article comprises a thermoplastic polymer shaped to comprise a curve comprising a curvature radius of up to 20 mm, wherein at least a portion of the curve comprises a microstructured surface of utilitarian discontinuities, wherein the microstructured surface comprises peak structures and adjacent valleys, wherein the valleys have a maximum width ranging from 1 micron to 250 microns and the peak structures have a side wall angle of greater than 10 degrees, and wherein the peak structures and the curve are formed of a single piece of the thermoplastic polymer.

In a second aspect, a method of making a microstructured article is provided. The method comprises a) obtaining a tool shaped to comprise at least one of a protrusion or a concavity; b) disposing a microstructured film on at least a portion of the tool including the protrusion and/or the concavity; and c) thermoforming a single piece of thermoplastic polymer onto the tool to form a microstructured article shaped to comprise a curve comprising a curvature radius of up to 20 mm. The curve is an inverse of the protrusion or the concavity of the tool and at least a portion of the curve comprises a microstructured surface of utilitarian discontinuities being an inverse of a surface of the microstructured film. The microstructured surface comprises peak structures and adjacent valleys. The valleys have a maximum width ranging from 1 micron to 250 microns and the peak structures have a side wall angle of greater than 10 degrees.

In a third aspect, the present disclosure provides a tooling article. The tooling article comprises a tool shaped to comprise at least one of a protrusion or a concavity and a microstructured film disposed on at least a portion of the tool including the protrusion and/or the concavity. The microstructured film comprises peak structures and adjacent valleys, wherein the valleys have a maximum width ranging from 1 micron to 250 microns. The peak structures have a side wall angle of greater than 10 degrees.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1 is a perspective review of a Cartesian coordinate system of a surface that can be utilized to describe various microstructured surfaces;

FIG. 2 is a cross-sectional view of a microstructured surface;

FIG. 2A is a perspective view of a microstructured surface;

FIG. 3 is a perspective view of a microstructured surface comprising a linear array of prisms;

FIG. 4A is a perspective view of a microstructured surface comprising an array of cube corner elements;

FIG. 4B is a perspective view of a microstructured surface comprising an array of pyramid elements;

FIG. 4C is a perspective view illustrating the dimensions and angles of a cube corner element;

FIG. 5 is a perspective view of a microstructured surface comprising an array of preferred geometry cube corner elements;

FIG. 6 is a cross-sectional view of peak structures with various apex angles;

FIG. 7 is a flow chart of an exemplary method according to the present disclosure;

FIG. 8A is an optical micrograph image of a microstructured tooling film;

FIG. 8B is a generalized schematic perspective view of a tool comprising a plurality of protrusions and concavities, having a shape of a dental arch;

FIG. 8C is photograph of the microstructured tooling film of FIG. 8A disposed on a dental arch, with the microstructured surface on the exterior of the tooling film;

FIG. 8D is a photograph of an exemplary article thermoformed onto the microstructured tooling and dental arch of FIG. 8C;

FIG. 8E is an optical micrograph image of an interior surface of the exemplary article of FIG. 8D;

FIG. 8F is an optical micrograph image of a larger portion of the interior surface of the exemplary article of FIG. 8D;

FIG. 9A is a photograph of a microstructured tooling film disposed on a dental arch, with the microstructured surface on the exterior of the tooling film and a portion of the tooling film removed near the incisor area of the dental arch;

FIG. 9B is a photograph of another exemplary article thermoformed onto the microstructured tooling and dental arch of FIG. 9A;

FIG. 9C is a photograph of the exemplary article of FIG. 9B after removal from the dental arch; and

FIG. 9D is an optical micrograph image of a portion of the interior surface of the exemplary article showing differentially microstructured areas between the location of the microstructured tooling and where a portion of the film had been removed from the dental arch.

FIG. 10 is a photograph of a tray prepared according to the process of Comparative Example 4.

FIG. 11A is an optical micrograph image of a portion of a 762 micron thick thermoformed microstructured tooling film.

FIG. 11B is an optical micrograph image of a portion of a 254 micron thick thermoformed microstructured tooling film.

While the above-identified figures set forth various embodiments of the disclosure, other embodiments are also contemplated, as noted in the description. In all cases, this disclosure presents the invention by way of representation and not limitation. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

### Glossary

As used herein, the term “arch” refers to a semicircular shape.

As used herein, “curvature radius” is the reciprocal of the curvature of a curve.

As used herein, “concavity” refers to a surface or an object that has a concave shape.

As used herein, “integral” refers to being made at the same time or being incapable of being separated without damaging one or more of the (integral) parts.

As used herein, “utilitarian” means that the discontinuities provide a positive contribution to the functioning of the article. For instance, easy-clean utilitarian discontinuities provide a positive contribution to the function of cleaning an article easier than an article lacking the utilitarian discontinuities. Representative examples of utilitarian discontinuities include, but are not limited to, cube-corner elements and parallel linear prisms with planar facets.

As used herein, “draw down” as used herein means extending a molten resin as it is being thermoformed. The draw down is characterized by a draw down ratio (DDR), which is the ratio of the surface area of a part to the footprint of the part. In general, the draw-down ratio for thermoplastic materials used herein is suitably from 1.1 to 3.

As used herein, the term “crack” refers to a break in a surface of a material or a change in a thickness of a material, each without complete separation of the material.

As used herein, the term “macrocrack” refers to a crack having at least one dimension that is greater than 250 microns in length.

As used herein, the term “microcrack” refers to a crack in which each dimension is 250 microns in length or shorter.

As used herein, the term “essentially free” in the context of a composition being essentially free of a component, refers to a composition containing less than 1% by weight (wt. %), 0.5 wt. % or less, 0.25 wt. % or less, 0.1 wt. % or less, 0.05 wt. % or less, 0.001 wt. % or less, or 0.0001 wt. % or less of the component, based on the total weight of the composition.

As used herein, “thermoplastic” refers to a polymer that flows when heated sufficiently above its glass transition point and become solid when cooled.

As used herein, “thermoset” refers to a polymer that permanently sets upon curing and does not flow upon subsequent heating. Thermoset polymers are typically crosslinked polymers.

As used herein, the term “glass transition temperature” (Tg), of a polymer refers to the transition of a polymer from a glassy state to a rubbery state and can be measured using Differential Scanning Calorimetry (DSC), such as at a heating rate of 10° C. per minute in a nitrogen stream. When the Tg of a monomer is mentioned, it is the Tg of a homopolymer of that monomer. The homopolymer must be sufficiently high molecular weight such that the Tg reaches a limiting value, as it is generally appreciated that a Tg of a homopolymer will increase with increasing molecular weight to a limiting value. The homopolymer is also understood to be substantially free of moisture, residual monomer, solvents, and other contaminants that may affect the Tg. A suitable DSC method and mode of analysis is as described in Matsumoto, A. et. al., J. Polym. Sci. A., Polym. Chem. 1993, 31, 2531-2539.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

Although articles with specific microstructure features are useful for reducing the initial formation of a biofilm, particularly for medical articles; in the case of other articles, such microstructured surfaces can be difficult to clean. This is surmised to be due at least in part to the bristles of a brush or fibers of a (e.g., nonwoven) wipe being larger than the space between microstructures. It has been found that some types of microstuctured surfaces exhibit better microorganism (e.g., bacteria) removal when cleaned, even in comparison to smooth surfaces. The article is typically not a sterile implantable medical article. Rather, the microstructured surface typically comes in contact with people and/or animals as well as other contaminants (e.g., dirt). Some representative articles include for example surfaces or component of a medical article, a dental article, an orthodontic article (e.g., an orthodontic aligner), a vehicular article, an electronic article, a personal care article, a cleaning article, an athletic article, a food preparation article, a child care article, or an architectural article.

As noted above, it can be challenging to achieve strong interfacial adhesion between two different material materials, for instance when the materials are thermoformed together. It has been discovered that it is possible to form an article that includes a curved microstructured surface from just one material, using thermoforming. Stated another way, the microstructured surface is integral to the curve of the thermoplastic polymer, as opposed to being a separate microstructured surface that has been attached to the curve of the thermoplastic polymer.

In a first aspect, a microstructured article is provided. The microstructured article comprises a thermoplastic polymer shaped to comprise a curve comprising a curvature radius of up to 20 millimeters (mm). At least a portion of the curve comprises a microstructured surface of utilitarian discontinuities, wherein the microstructured surface comprises peak structures and adjacent valleys, wherein the valleys have a maximum width ranging from 1 micron to 250 microns and the peak structures have a side wall angle of greater than 10 degrees. The peak structures and the curve are formed of a single piece of the thermoplastic polymer.

In contrast to a curved surface, a flat surface has a curvature radius of infinity. In some embodiments, the curve comprises a minimum curvature radius of 0.5 mm, such as 0.5 mm or greater, 0.6 mm, 0.7 mm, 0.8 mm, 0.9 mm, 1.0 mm, 1.25 mm, 1.5 mm, 1.75 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm or greater; and 20.0 mm or less, 19.5 mm, 19.0 mm, 18.5 mm, 18.0 mm, 17.5 mm, 17.0 mm, 16.5 mm, 16.0 mm, 15.5 mm, 15.0 mm, 14.5 mm, 14.0 mm, 13.5 mm, 13.0 mm, 12.5 mm, 12.0 mm, 11.5 mm, or 11.0 mm or less.

The microstructured surface typically provides a log 10 reduction of microorganism (e.g., bacteria) of at least 2, 3, 4, 5, 6, 7, or 8 after cleaning. Regardless of whether the microstructured surface is mechanically cleaned with a wipe or brush and/or cleaned by applying an antimicrobial solution to the microstructured surface, the microstructured surface provides improved removal of microorganism (e.g., bacteria) in comparison to surfaces lacking the microstructures.

In a second aspect, a method of making a microstructured article is provided. The method comprises a) obtaining a tool shaped to comprise at least one of a protrusion or a concavity; b) disposing a microstructured film on at least a portion of the tool including the protrusion and/or the concavity; and c) thermoforming a single piece of thermoplastic polymer onto the tool to form a microstructured article shaped to comprise a curve comprising a curvature radius of up to 20 mm. The curve is an inverse of the protrusion or the concavity of the tool and at least a portion of the curve comprises a microstructured surface of utilitarian discontinuities being an inverse of a surface of the microstructured film. The microstructured article can be any article according to the first aspect.

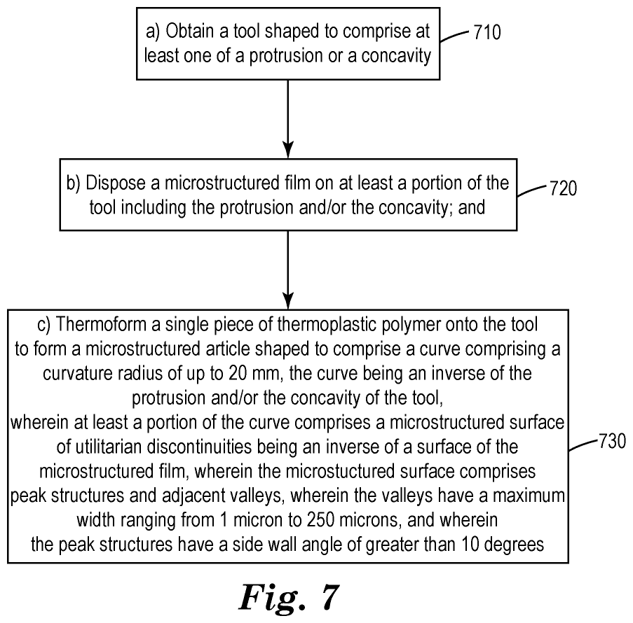

Referring to FIG. 7, the method of making a microstructured article comprises a Step 710 to a) obtain a tool shaped to comprise at least one of a protrusion or a concavity and a Step 720 to b) dispose a microstructured film on at least a portion of the tool including the protrusion and/or the concavity. The method further comprises a Step 730 to c) thermoform a single piece of thermoplastic polymer onto the tool to form a microstructured article shaped to comprise a curve comprising a curvature radius of up to 20 mm, the curve being an inverse of the protrusion and/or the concavity of the tool, wherein at least a portion of the curve comprises a microstructured surface of utilitarian discontinuities being an inverse of a surface of the microstructured film, wherein the microstructured surface comprises peak structures and adjacent valleys, wherein the valleys have a maximum width ranging from 1 micron to 250 microns, and wherein the peak structures have a side wall angle of greater than 10 degrees.

Accordingly, a microstructured surface can be imparted to an article having at least one curved surface by thermoforming a single piece of thermoplastic polymer onto a tool having a protrusion, in which a microstructured film is disposed on at least one of a protrusion or a concavity, with the microstructures located on the film opposite the protrusion, the concavity, or both.

Variations in how the steps of the method are performed are contemplated. For instance, the microstructured film may be attached to the thermoplastic polymer and steps b) and c) may be performed at least partially simultaneously. Optionally, the microstructured film is disposed on the tool according to step b) by thermoforming the microstructured film onto the tool simultaneously with step c). In some methods, the microstructured film is attached (e.g., by thermoforming) to an exterior surface of the tool, including over at least a portion of a protrusion and/or a concavity. Suitable methods may comprise thermoforming a thermoplastic polymer onto the microstructured base film at a temperature below the melt temperature of the peak structures of the microstructured (e.g., tooling) film. In some embodiments, vacuum forming may be used in combination with thermoforming, also known as dual vacuum thermoforming (DVT).

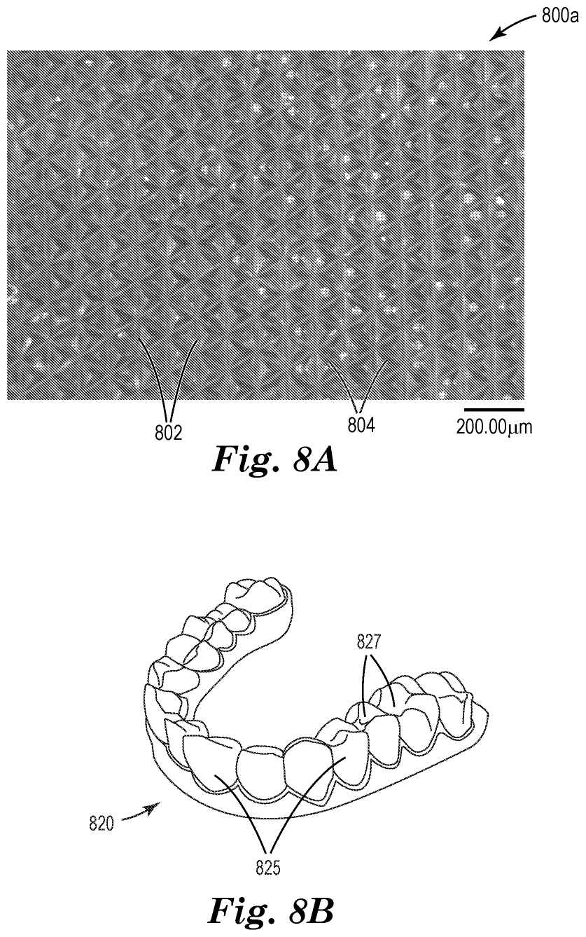

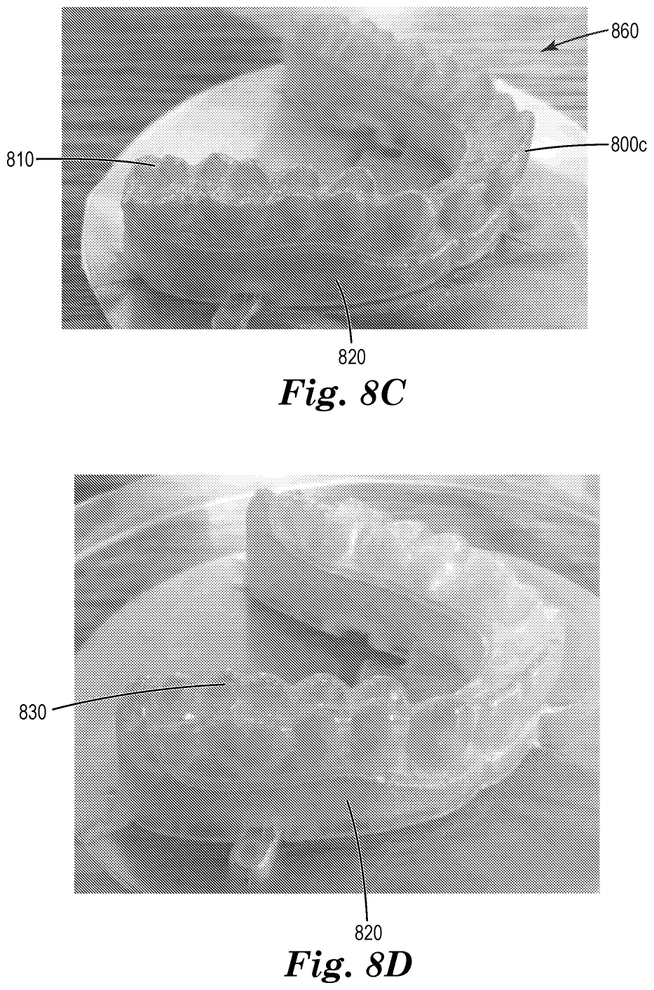

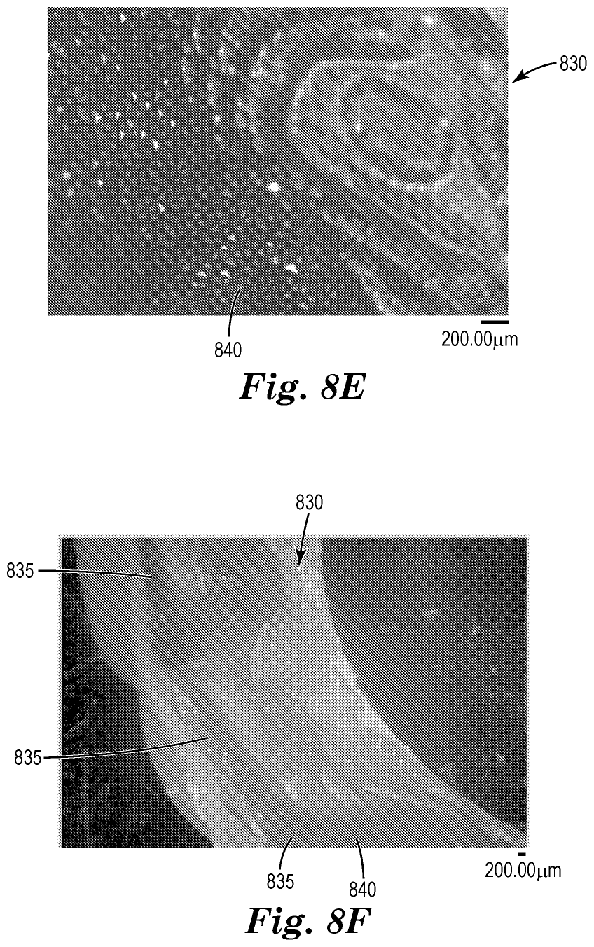

Any tool shape can be used to provide a portion of material that extends beyond, above, or below a planar surface, to impart a curve into a final article thermoformed onto at least one of a protrusion or a concavity of the tool, in which the (e.g., first) curve of the article is the inverse of the protrusion or the concavity. One suitable example is a dental arch (see, e.g., FIG. 8B). Dental arches are well known to be used as a tool in forming a dental tray for an individual (e.g., a dental tray can include a dental aligner, a night guard, a mouth guard, a treatment tray, complete or partial dentures, a tooth cap, or the like). A dental aligner may allow for repositioning misaligned teeth for improved cosmetic appearances and/or dental function. A night guard may be worn by a user to minimize damage to teeth during tooth grinding. A mouth guard may be, for example, a sports mouth guard that may or may not be formed to a user's mouth with heat. A treatment tray may allow administration of a medication to oral surfaces, e.g., teeth whitening, remineralization, gum disease treatments, or the like. In some embodiments, the dental tray may provide aesthetic appeal by providing color (e.g., whitening).

An advantage of forming a microstructured article according to the present disclosure includes being able to employ a (e.g., standard) microstructured film with any custom-made tool (such as a dental arch prepared for a particular individual), and then create an integral custom article having a microstructured surface. Tools can readily be formed by making one or more molds of a shape of interest, via additive manufacturing (e.g., using a digital scan of the desired shape), or other processes. In certain methods, step a) of the method comprises making the tool using an additive manufacturing process, e.g., stereolithography (SLA).

Referring to FIG. 8A, an optical micrograph image is provided of a microstructured (e.g., tooling) film 800a suitable for use in methods according to the present disclosure. The microstructured film 800a is formed of polyvinyl chloride and includes a plurality of peaks 802 and valleys 804. The peaks 802 and valleys 804 are configured to essentially be an inverse of the peaks and valleys of a microstructured surface of utilitarian discontinuities of the microstructured surface of microstructured articles according to the present disclosure. By “essentially” being an inverse, it is understood that due to the microstructured surface of microstructured articles being located at least partially on a curved surface of an article, the microstructured surface will not be identically inverse to a planar microstructured (tooling) film. Rather, for instance, some angles between adjacent peaks may be different when located on a curve than when located on a flat base.

An overall thickness of exemplary microstructured films can vary, such as an average thickness of 25 microns or greater, 30, 40, 50, 60, 70, 80, 90, 100, 120, 140, 160, 180, 200, 220, 240, or 260 microns or greater; and 400 microns or less, 380, 360, 340, 320, 300, 280, 250, 225, 200, 175, or 150 microns or less. In select embodiments, an average thickness of a microstructured film may be 25 to 380 microns or 50 to 260 microns. It was unexpectedly found that in some cases, an average thickness of 380 microns or less contributed to a microstructured film that is more resistant to macrocracks when thermoformed than the same microstructured film having a larger average thickness.

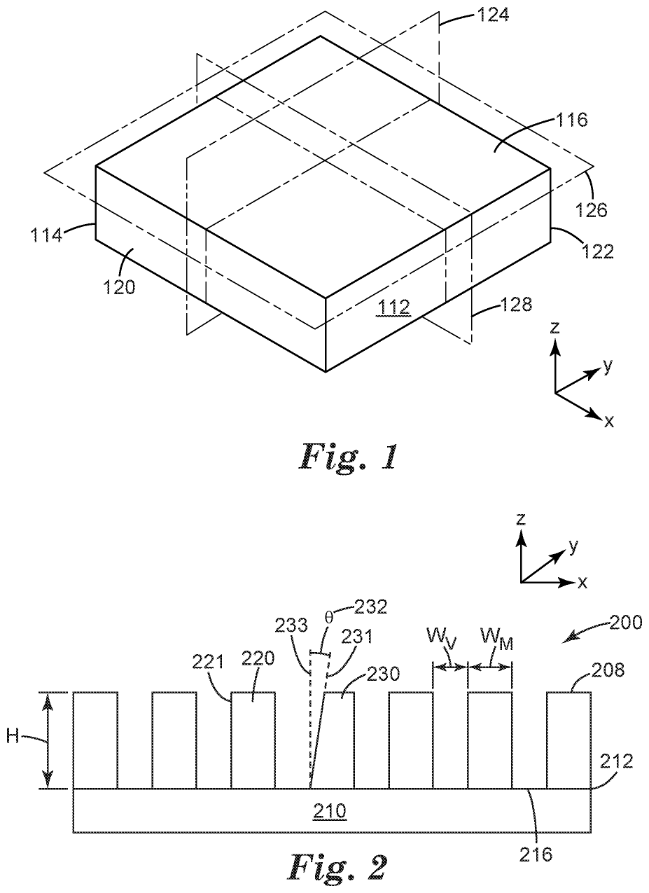

Suitable microstructured films useful as tooling films for methods according to the present disclosure have an inverse microstructure to the desired microstructure of the final microstructured article. Such desired microstructure present on a surface of an article is as described in detail below with respect to FIGS. 1-6:

With reference to FIG. 1, a microstructured surface can be characterized in three-dimensional space by superimposing a Cartesian coordinate system onto its structure. A first reference plane 124 is centered between major surfaces 112 and 114. First reference plane 124, referred to as the y-z plane, has the x-axis as its normal vector. A second reference plane 126, referred to as the x-y plane, extends substantially coplanar with surface 116 and has the z-axis as its normal vector. A third reference plane 128, referred to as the x-z plane, is centered between first end surface 120 and second end surface 122 and has the y-axis as its normal vector.

In some embodiments, the microstructured surfaces are three-dimensional on a macroscale. However, on a microscale (e.g., surface area that includes at least two adjacent microstructures with a valley or channel disposed between the microstructures) the base layer/base member can be considered planar with respect to the microstructures. The width and length of the microstructures are in the x-y plane and the height of the microstructures is in the z-direction. Further, the base layer is parallel to the x-y plane and orthogonal to the z-plane.

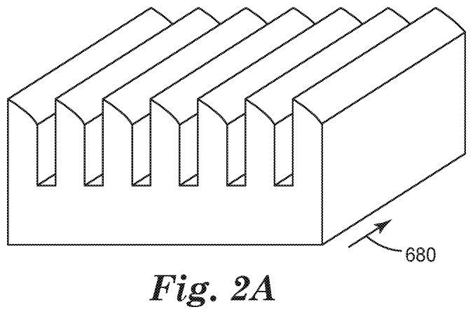

FIG. 2 is an illustrative cross-section of a microstructured surface 200 of utilitarian discontinuities. Such cross-section is representative of a plurality of discrete (e.g., post or rib) microstructures 220. The microstructures comprise a base 212 adjacent to an (e.g., engineered) planar surface 216 (surface 116 of FIG. 1 that is parallel to reference plane 126). Top (e.g., planar) surfaces 208 (parallel to surface 216 and reference plane 26 of FIG. 1) are spaced from the base 212 by the height (“H”) of the microstructure. The side wall 221 of microstructure 220 is perpendicular to planar surface 216. When the side wall 221 is perpendicular to planar surface 216, the microstructure has a side wall angle of zero degrees. In the case of perpendicular side walls, of a peak microstructure are parallel to each other and parallel to adjacent microstructures having perpendicular side walls. Alternatively, microstructure 230 has side wall 231 that is angled rather than perpendicular relative to planar surface 216. The side wall angle 232 can be defined by the intersection of the side wall 231 and a reference plane 233 perpendicular to planar surface 216 (perpendicular to reference plane 126 and parallel to reference plane 128 of FIG. 1). In the case of privacy films, for instance, such as described in U.S. Pat. No. 9,335,449 (Gaides et al.); the wall angle is typically less than 10, 9, 8, 7, 6, or 5 degrees. Since the channels of privacy film comprise light absorbing material, larger wall angle can decrease transmission. However, wall angles approaching zero degrees are also more difficult to clean.

Suitable surfaces are microstructured surfaces comprising microstructures having side wall angles greater than 1, 2, 3, 4, 5, 6, 7, 8, 9, or 10 degrees. In some embodiments, the side wall angle is at least 11, 12, 13, 14, 15, 16, 17, 18, 19, or 20 degrees. In other embodiments, the side wall angle is at least 21, 22, 23, 24, 25, 26, 27, 28, 29, or 30 degrees. For example, in some embodiments, the microstructures are cube corner peak structures having a side wall angle of 30 degrees. In other embodiments, the side wall angle is at least 31, 32, 33, 34, 35, 36, 37, 38, 39, 40, 41, 42, 43, 44, or 45 degrees. For example, in some embodiments, the microstructures are prism structures having a side wall angle of 45 degrees. In other embodiments, the side wall angle is at least 46, 47, 48, 49, 50, 51, 52, 53, 54, 55, 56, 57, 58, 59, or 60 degrees. It is appreciated that the microstructured surface would be beneficial even when some of the side walls have lower side wall angles. For example, if half of the array of peak structures have side wall angles within the desired range, about half the benefit of improved microorganism (e.g., bacteria) removal may be obtained. Thus, in some embodiments, less than 50, 45, 40, 35, 30, 25, 20, 15, 10, 5 or 1% of the peak structures have side wall angles less than 10, 9, 8, 7, 6, 5, 4, 3, 2, or 1 degree. In some embodiments, less than 50, 45, 40, 35, 30, 25, 20, 15, 10, 5 or 1% of the peak structures have side wall angles less than 30, 25, 20, or 15 degrees. In some embodiments, less than 50, 45, 40, 35, 30, 25, 20, 15, 10, 5 or 1% of the peak structures have side wall angles less than 40, 35, or 30 degrees, at least 50, 60, 70, 80, 90, 95 or 99% of the peak structures have a sufficiently large side wall angle, as described above.

As described for example in PCT Publication No. WO 2013/003373 (Bommarito et al.), microstructures having a cross-sectional dimension no greater than 5 microns are believed to substantially interfere with the settlement and adhesion of target bacteria most responsible for healthcare-associated infections or other biofouling problems such an increased drag, reduced heat transfer, filtration fouling, etc. With reference to FIG. 2, the cross-sectional width of the microstructure (“W_{M}”) as depicted in this figure, is less than or equal to the cross-sectional width of the channel or valley (“Wv”) between adjacent microstructures. Thus, as depicted (in this linear prism embodiment), when the cross-section width of the microstructure (W_{M}) is no greater than 5 microns, the cross-sectional width of the channel or valley (Wv) between microstructures is also no greater than 5 microns. When the microstructures on either side of a valley have a side wall angel of zero, such as depicted by microstructure 220 of FIG. 2, the channel or valley defined by the side walls has the same width (Wv) adjacent the top surface 208 as adjacent the bottom surface 212. When the microstructure has a side wall angle of greater than zero, such as depicted by the line 231 of microstructure 230, the valley typically has a greater (e.g., maximum) width adjacent the top surface 208 as compared to the width of the channel or valley adjacent the bottom surface 212. It has been found that when the side wall angle is too small, and/or the maximum width of the valley is too small, and/or the microstructured surface comprises an excess amount of flat surface area, the microstructured surface is more difficult to clean.

Suitable microstructured surfaces comprise microstructures wherein the maximum width of the valleys is at least 1, 2, 3, or 4 microns and optionally greater than 5, 6, 7, 8, 9, or 10 microns, ranging up to 250 microns. In some embodiments, the maximum width of the valleys is at least 1, 2, 3, 4, 5, 6, 7, 8, 9, 10, 11, 12, 13, 14, 15, 16, 17, 18, 19, 20, 21, 22, 23, 24, or 25 microns. In some embodiments, the maximum width of the valleys is no greater than 1000, 950, 900, 850, 800, 750, 700, 650, 600, 550, 500, 450, 400, 350, 300, 250, 225, 200, 175, 150, 125, 100, 75, or 50 microns. In some embodiments, the maximum width of the valleys is no greater than 45, 40, 35, 30, 25, 20, or 15 microns. It is appreciated that the microstructured surface would be beneficial even when some of the valleys are less than the maximum width. For example, if half of the total number of valleys of the microstructured surface are within the desired range, about half the benefit may be obtained. Thus, in some embodiments, less than 50, 45, 40, 35, 30, 25, 20, 15, 10, 5 or 1% of the valleys have a maximum width of less than 10, 9, 8, 7, 6, or 5 microns. Alternatively, at least 50, 60, 70, 80, 90, 95 or 99% of the valleys have a maximum width, as described above.

In typical embodiments, the maximum width of the microstructures falls within the same ranges as described for the valleys. In other embodiments, the width of the valleys can be greater than the width of the microstructures. Thus, in some favored embodiments, the microstructured surface is typically substantially free of microstructures having a width less than 5, 4, 3, 2, or 1 micron, inclusive of nanostructures having a width less than 1 micron. By substantially free, it is meant that there are none of such microstructures present or that some may be present provided that the presence thereof does not detract from the cleanability properties as will subsequently described.

Although smaller structures including nanostructures can prevent biofilm formation, the presence of a significant number of smaller valleys and/or valleys with insufficient side wall angles can impede cleanability including dirt removal. Further, microstructured surfaces with larger microstructures and valleys can typically be manufactured at a faster rate. Thus, in typical embodiments, each of the dimensions of the microstructures is at least 1, 2, 3, 4, 5, 6, 7, 8, 9, 10, 11, 12, 13, 14, or 15 microns. Further, in certain embodiments, none of the dimensions of at least 50, 60, 70, 80, 90, 95 or 99% microstructures are less than 5, 4, 3, 2, or 1 micron.

The valleys of suitable microstructured surfaces are substantially free of intersecting side walls or other obstructions to the valley. By substantially free, it is meant that there are no side walls or other obstructions present within the valleys or that some may be present provided that the presence thereof does not detract from the cleanability properties. The valleys are typically continuous in at least one direction. This can facilitate the flow of a cleaning solution through the valley. Thus, the arrangement of peaks typically does not define a tortuous pathway.

The peak structures typically have a height (H) ranging from 1 to 250 microns. In some embodiments, the height of the microstructures is at least 2, 3, 4, or 5 microns. In some embodiments, the height of the microstructures is at least 6, 7, 8, 9 or 10 microns. In some embodiments, the height of the microstructures no greater than 225, 200, 175, 150, 125, 100, 90, 80, 70, 60, or 50 microns. In some embodiments, the height of the microstructures is no greater than 45, 40, 35, 30 or 25 microns. In some embodiments, the height of the microstructures is no greater than 24, 23, 22, 21, 20, 19, 18, 17, 16, 15, 14, 13, 12, 11, 10, 9, 8, 7, 6, or 5 microns. In select embodiments, the peak structures each have a height of 10 to 250 microns. It was unexpectedly found that in some cases, a peak structure height of at least 10 microns contributed to a microstructured film that is more resistant to macrocracks when thermoformed than the same microstructured film having a peak structure height of less than 10 microns. In typical embodiments, the height of the valley or channel is within the same range as just described for the peak structures. In some embodiments, the peak structures and valleys have the same height.

The aspect ratio of the valley is the height of the valley (which can be the same as the peak height of the microstructure) divided by the maximum width of the valley. In some embodiments, the aspect ratio of the valley is at least 0.1, 0.15, 0.2, or 0.25. In some embodiments, the aspect ratio of the valley is no greater than 1, 0.9, 0.8, 0.7, 0.6 or 0.5. Thus, in some embodiments, the height of the valley is typically no greater than the maximum width of the valley, and more typically less than the maximum width of the valley.

The base of each microstructure may comprise various cross-sectional shapes including but not limited to parallelograms with optionally rounded corners, rectangles, squares, circles, half-circles, half-ellipses, triangles trapezoids, other polygons (e.g., pentagons, hexagons, octagons, etc., and combinations thereof).

Suitable microstructured surfaces comprise an array of peak structures and adjacent valleys. The valleys preferably have a maximum width ranging from 1 micron to 250 microns. In some embodiments (e.g., for improved cleanability), the peak structures have a side wall angle greater than 10 degrees. The peak structures may comprise two or more facets such as in the case of a linear array of prisms or an array of cube-corners elements. In some embodiments, facets of the peak structures form an apex angle, typically ranging from about 20 to 120 degrees. The facets form continuous or semi-continuous surfaces in the same direction. The valleys typically lack intersecting walls.

The presently described microstructured surface does not prevent microorganisms (e.g., bacteria such as Streptococcus mutans, Staphylococcus aureus, or Pseudomonas aeruginosa) from being present on the microstructured surface, or in other words, does not prevent biofilm from forming. However, such microstructured surfaces have been demonstrated to be easier to clean, providing a low amount of microorganism (e.g., bacteria) present after cleaning. Without intending to be bound by theory, scanning electron microscopy images suggest that large continuous biofilms typically form on a smooth surface. However, even though the peaks and valleys are much larger than the microorganism (e.g., bacteria), the biofilm is interrupted by the microstructured surface. In some embodiments, the biofilm (before cleaning) is present as discontinuous aggregate and small groups of cells on the microstructured surface, rather than a continuous biofilm. After cleaning, biofilm aggregates in small patches cover the smooth surface. However, the microstructured surface was observed to have only small groups of cells and individual cells after cleaning. In favored embodiments, the microstructured surface provides a log 10 reduction of microorganism (e.g., bacteria such as Streptococcus mutans, Staphylococcus aureus, or Pseudomonas aeruginosa) of at least 2, 3, 4, 5, 6, 7 or 8 after cleaning. In some embodiments, the microstructured surface has a mean log 10 of recovered colony forming units of microorganism of less than 6, 5, 4, or 3 after cleaning for a highly contaminated surface.

In some embodiments, the microstructured surface can prevent an aqueous or (e.g., isopropanol) alcohol-based cleaning solution from beading up as compared to a smooth surface comprised of the same polymeric material. When a cleaning solution beads up or in other words dewets, the disinfectant agent may not be in contact with a microorganism for a sufficient duration of time to kill the microorganism. However, it has been found that at least 50, 60, 70, 80, or 90% of the microstructured surface can comprise cleaning solution 1, 2, and 3 minutes after applying the cleaning solution to the microstructured surface.

In one embodiment, the microstructured surface may have the same surface as a brightness enhancing film. As described for example in U.S. Pat. No. 7,074,463 (Jones et al.), backlit liquid crystal displays generally include a brightness enhancing film positioned between a diffuser and a liquid crystal display panel. The brightness enhancing film collimates light, thereby increasing the brightness of the liquid crystal display panel and also allowing the power of the light source to be reduced. Thus, brightness enhancing films have been utilized as an internal component of an illuminated display devices (e.g., cell phone, computer) that are not exposed to microorganisms (e.g., bacteria) or dirt.

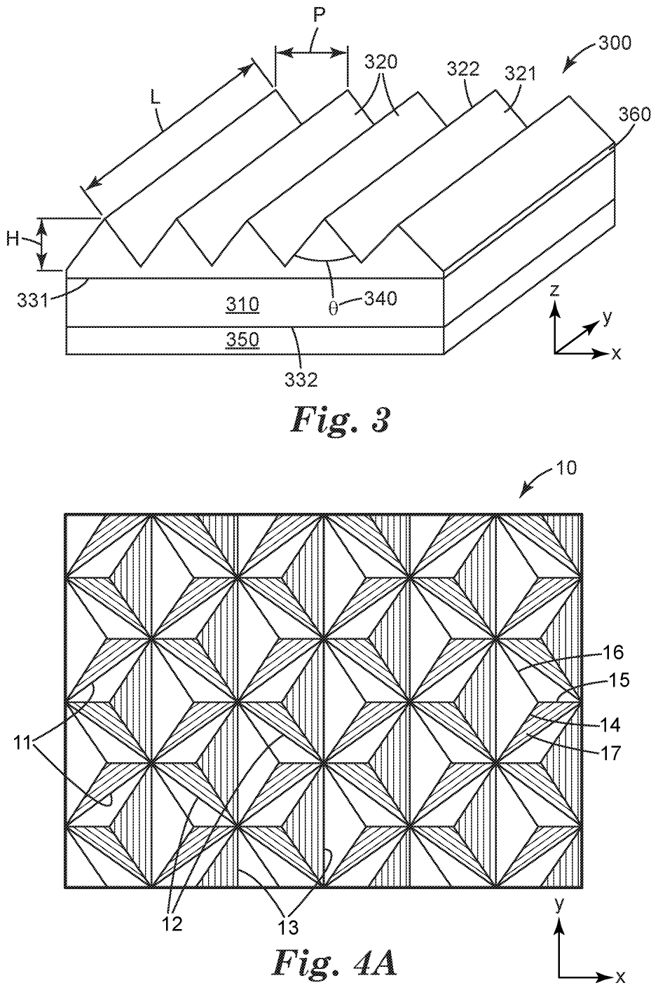

With reference to FIG. 3, in one embodiment, the microstructured surface 300 comprises a linear array of regular right prisms 320. Each prism has a first facet 321 and a second facet 322. The prisms are illustrated as formed on a base member 310 that has a first planar surface 331 (parallel to reference plane 126) on which the prisms are formed and a second surface 332 that is substantially flat or planar and opposite first surface. By right prisms it is meant that the apex angle θ, 340, is typically about 90°. However, this angle can range from 70° to 120° and may range from 80° to 100°. These apexes can be sharp (as shown), rounded, or truncated. The spacing between (e.g., prism) peaks may be characterized as pitch (“P”). In this embodiment, the pitch is also equal to the maximum width of the valley. Thus, the pitch is greater than 1, 2, 3, 4, 5, 6, 7, 8, 9, or 10 microns ranging up to 250 microns, as previously described. The length (“L”) of the (e.g., prism) microstructures is typically the largest dimension and can span the entire dimension of the microstructured surface. The prism facets need not be identical and the prisms may be tilted with respect to each other, as shown in FIG. 6.

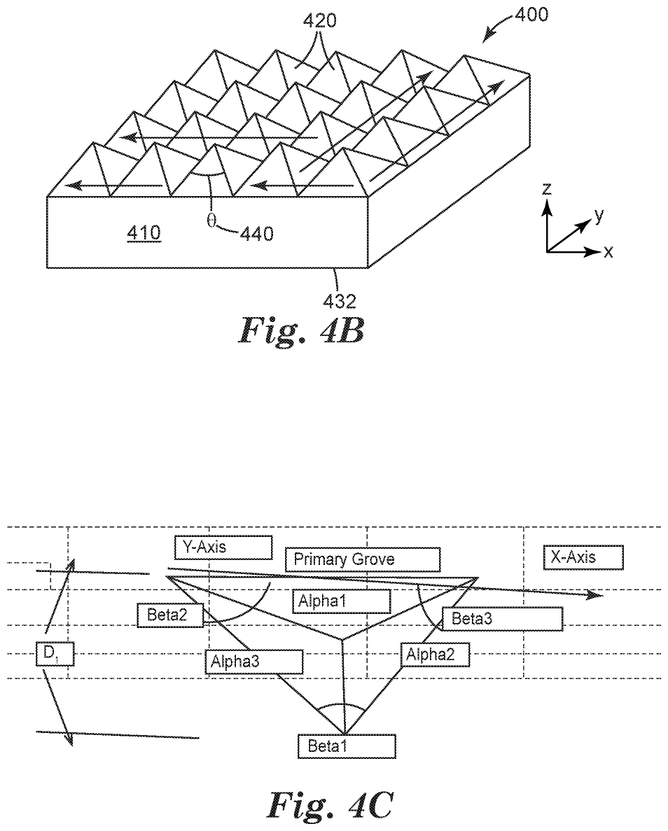

In another embodiment, the microstructured surface may have the same surface as cube corner retroreflective sheeting. Retroreflective materials are characterized by the ability to redirect light incident on the material back toward the originating light source. This property has led to the widespread use of retroreflective sheeting for a variety of traffic and personal safety uses. With reference to FIG. 4A, cube corner retroreflective sheeting typically comprises a thin transparent layer having a substantially planar front surface and a rear structured surface 10 comprising a plurality of cube corner elements 17. A seal film (not shown) is typically applied to the backside of the cube-corner elements; see, for example, U.S. Pat. No. 4,025,159 (McGrath) and U.S. Pat. No. 5,117,304 (Huang et al.). The seal film maintains an air interface at the backside of the cubes that enables total internal reflection at the interface and inhibits the entry of contaminants such as soil and/or moisture.

The microstructured surface 10 of FIG. 4A may be characterized as an array of cube corner elements 17 defined by three sets of parallel grooves (i.e., valleys) 11, 12, and 13; two sets of grooves (i.e., valleys) intersect each other at an angle greater than 60 degrees and a third set of grooves (valleys) intersects each of the other two sets at an angle less than 60 degrees to form an array of canted cube corner element matched pairs (see U.S. Pat. No. 4,588,258 (Hoopman)). The angles for the grooves are chosen such that the dihedral angle formed at the linear of intersection of the grooves, e.g., 14, 15, and 16 for representative cube-corner element 17 are about 90 degrees. In some embodiments, the triangular base has angle of at least 64, 65, 66, 67, 68, 69, or 70 degrees and the other angles are 55, 56, 57, or 58 degrees.

In another embodiment, depicted in FIG. 4B, the microstructured surface 400 of FIG. 4B may be characterized as an array of pyramidal peak structures 420 defined by a first set of parallel grooves (i.e., valleys) in the y direction and a second set of parallel groves in the x direction. The base of the pyramidal peak structures is a polygon, typically a square or rectangle depending on the spacing of the grooves. The apex angle θ, 440, is typically about 90°. However, this angle can range from 700 to 1200 and may range from 800 to 100°. In other embodiments, the apex angle is at least 20°, 30°, 40°, 50°, or 60°.

Other cube corner element structures, described as “full cubes” or “preferred geometry (PG) cube corner elements”, typically comprise at least two non-dihedral edges that are not coplanar as described for example in U.S. Pat. No. 7,188,960 (Smith); incorporated herein by reference. Full cubes are not truncated. In one aspect, the base of full cube elements in plan view are not triangular. In another aspect, the non-dihedral edges of full cube elements are characteristically not all in the same plane (i.e., not coplanar). Such cube corner elements may be characterized as “preferred geometry (PG) cube corner elements”. A PG cube corner element may be defined in the context of a structured surface of cube corner elements that extends along a reference plane. A PG cube corner element means a cube corner element that has at least one non-dihedral edge that: (1) is nonparallel to the reference plane; and (2) is substantially parallel to an adjacent non-dihedral edge of a neighboring cube corner element. A cube corner element with reflective faces that comprise rectangles (inclusive of squares), trapezoids or pentagons are examples of PG cube corner elements.

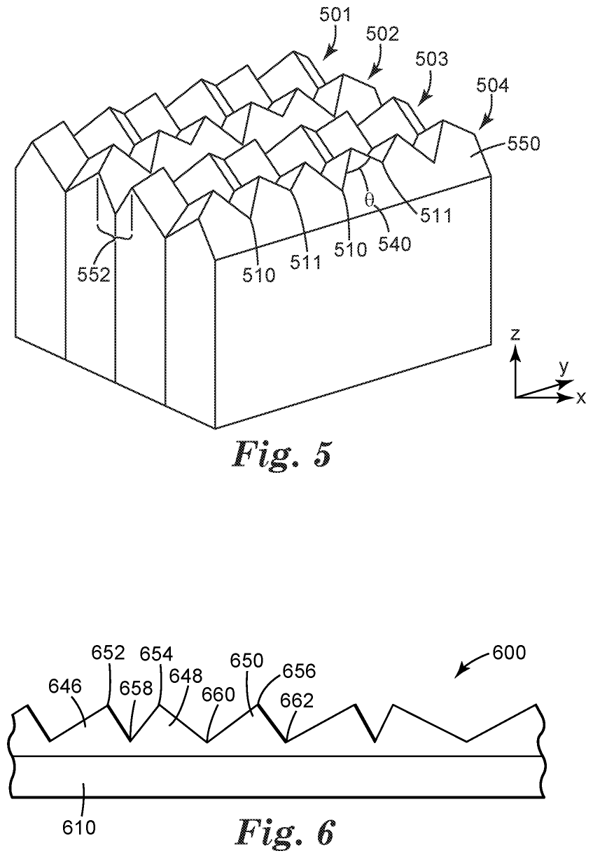

With reference to FIG. 5, in another embodiment the microstructured surface 500 may comprise an array of preferred geometry (PG) cube corner elements. The illustrative microstructured surface comprises four rows (501, 502, 503, and 504) of preferred geometry (PG) cube corner elements. Each row of preferred geometry (PG) cube corner elements has faces formed from a first and second groove set also referred to as “side grooves”. Such side grooves range from being nominally parallel to non-parallel to within 1 degree to adjacent side grooves. Such side grooves are typically perpendicular to reference plane 124 of FIG. 1. The third face of such cube corner elements preferably comprises a primary groove face 550. This primary groove face ranges from being nominally perpendicular to non-perpendicular within 1 degree to the face formed from the side grooves. In some embodiments, the side grooves can form an apex angle θ, of nominally 90 degrees. In other embodiments, the row of preferred geometry (PG) cube corner elements comprises peak structures formed from an alternating pair of side grooves 510 and 511 (e.g., about 75 and about 105 degrees) as depicted in FIG. 5. Thus, the apex angle 540 of adjacent (PG) cube corner elements can be greater than or less than 90 degrees. In some embodiments, the average apex angle of adjacent (PG) cube corner elements in the same row is typically 90 degrees. As described in previously cited U.S. Pat. No. 7,188,960, during the manufacture of a microstructured surface comprising PG cube corner elements, the side grooves can be independently formed on individual lamina (thin plates), each lamina having a single row of such cube corner elements. Pairs of laminae having opposing orientation are positioned such that their respective primary groove faces form primary groove 552, thereby minimizing the formation of vertical walls. The lamina can be assembled to form a microstructured surface which is then replicated to form a tool of suitable size.

In some embodiments, all the peak structures have the same apex angle θ. For example, the previously described microstructured surface of FIG. 3 depicts a plurality of prism structures, each having an apex angle θ of 90 degrees. As another example, the previously described microstructured surface of FIG. 4B depicts a plurality of pyramidal structures, each having an apex angle θ of 60 degrees. In other embodiments, the peak structures may form apex angles that are not the same. For example, as depicted in FIG. 5, some of the peak structures may have an apex angle greater than 90 degrees and some of the peak structures may have an apex angle less than 90 degrees. In some embodiments, the peak structures of an array of microstructures have peak structures with different apex angles, yet the apex angles average a value ranging from 60 to 120 degrees. In some embodiments, the average apex angle is at least 65, 70, 75, 80, or 85 degrees. In some embodiments, the average apex angle is less than 115, 110, 100, or 95 degrees.

As yet another example, as depicted in the cross-section of FIG. 6, the microstructured surface 600 may comprise a plurality of peak structures such as 646, 648, and 650 having peaks 652, 654, and 656, respectively. When the microstructured surface is free of flat surfaces, (i.e., surfaces that are parallel to reference plane 126 of FIG. 1), the facets of adjacent peak structures may also define the valley between adjacent peaks. In some embodiments, the facets of the peak structure form a valley with a valley angle of less than 90 degrees (e.g., valley 658). In some embodiments, the facets of the peak structure form a valley with a valley angle of greater than 90 degrees (e.g., valley 660). In some embodiments, the valleys are symmetrical, such as depicted by valleys 658 and 660. In other embodiments, the valleys are symmetrical such as depicted by valley 662. When the valley is symmetrical the side walls of adjacent peak structures that define the valley are substantially the same. When the valley is asymmetrical, the side walls of adjacent peak structures that define the valley are different. The microstructured surface may have a combination of symmetrical and asymmetrical valleys.

In some embodiments, the peak structures typically comprise at least two (e.g., prisms of FIG. 3), three (e.g., cube corners of FIG. 4A) or more facets. For example, when the base of the microstructure is an octagon the peak structures comprise eight side wall facets. However, when the facets have rounded or truncated surfaces, the microstructures may not be characterized by a specific geometric shape.

When the facets of the microstructures are joined such that the apex and valleys are sharp or rounded, but not truncated, the microstructured surface can be characterized are being free of flat surfaces, that are parallel to the planar base layer. However, wherein the apex and/or valleys are truncated, the microstructured surface typically comprises less than 50, 45, 40, 35, 30, 25, 20, 15, 10, 5 or 1% of flat surface area that is substantially parallel to the planar base layer. In one embodiment, the valleys may have flat surfaces and only one of the side walls of the peaks is angled such as shown in FIG. 2A. However, in favored embodiments, both side walls of adjacent peaks defining the valley(s) are angled toward each other, as previously depicted. Thus, the side walls on either side of a valley are not parallel to each other.

In each of the embodiments of FIGS. 3-6, the facets of adjacent (e.g., prism or cube corner) peak structures are typically connected at the bottom of the valley, i.e., proximate the planar base layer. The facets of the peak structures form a continuous surface in the same direction. For example, in FIG. 3, the facets 321 and 322 of the (e.g., prism) peak structures are continuous in the direction of the length (L) of the microstructures or in other words, the y-direction. As yet another example, the primary grooves 452 and 550 of the PG cube corner elements of FIG. 5 form a continuous surface in the y-direction. In other embodiments, the facets form a semi-continuous surface in the same direction. For example, in FIG. 4, facets of the (e.g., cube corner or pyramidal) peak structures are in the same plane in both the x- and y-directions. These semi-continuous and continuous surfaces can assist in the cleaning of pathogens from the surface.

In some embodiments, the apex angle of the peak structure is typically two times the wall angle, particularly when the facets of the peak structures are interconnected at the valleys between peak structures. Thus, the apex angle is typically greater than 20 degrees and more typically at least 25, 30, 35, 40, 45, 50, 55, or 60 degrees. The apex angle of the peak structure is typically less than 160 degrees and more typically less than 155, 150, 145, 140, 135, 130, 125 or 120 degrees.

Topography maps can be obtained using confocal laser scanning microscopy (CLSM), e.g., a Keyence VK-X200. CLSM is an optical microscopy technique that scans the surface using a focused laser beam to map the topography of a surface. CLSM works by passing a laser bean through a light source aperture which is then focused by an objective lens into a small area on the surface and image is built up pixel-by-pixel by collecting the emitted photons from the sample. It uses a pinhole to block out-of-focus light in image formation. Dimensional analysis can be used to measure various parameters using SPIP 6.7.7 image metrology software according to the manual (see https://www.imagemet.com/media-library/support-documents).

Surface roughness parameters, Sa (Roughness Average), Sq (Root Mean Square), and Sbi (Surface Bearing Index), Svi (Valley Fluid Retention Index) can be calculated from the topographic images (3D). Prior to calculating roughness, a plane correction is used “Subtract Plane” (1^{st} order planefit form removal).

### The Roughness Average, Sa, is Defined as:

$${S}_{a} = \frac{1}{MN} {\sum }_{k = 0}^{M - 1} {\sum }_{l = 0}^{N - 1} \vert z ( {x}_{k} , {y}_{l} ) \vert$$

where M and N are the number of data points X and Y.

Although smooth surfaces can have a Sa approaching zero, the comparative smooth surfaces that were found to have poor microorganism removal after cleaning had an average surface roughness, Sa, of at least 10, 15, 20, 25 or 30 nm. The average surface roughness, Sa, of the comparative smooth surfaces was less than 1000 nm (1 micron). In some embodiments, Sa of the comparative smooth surface was at least 50, 75, 100, 125, 150, 200, 250, 300, or 350 nm. In some embodiments, Sa of the comparative smooth surface was no greater than 900, 800, 700, 600, 500, or 400 nm.

The average surface roughness, Sa, of the microstructured surfaces having improved microorganism removal after cleaning was 1 micron (1000 nm) or greater. In some embodiments, Sa was at least 1100 nm, 1200 nm, 1300 nm, 1400 nm, 1500 nm, 1600 nm, 1700 nm, 1800 nm, 1900 nm, or 2000 nm (2 microns). In some embodiments, Sa of the microstructured surfaces was at least 2500 nm, 3000 nm, 3500 nm, 4000 nm or 5000 nm. In some embodiments, Sa of the microstructured surfaces was at least 10,000 nm, 15,000 nm, 20,000 nm or 25,000 nm. In some embodiments, Sa of the microstructured surfaces having improved microorganism removal after cleaning was no greater than 40,000 nm (40 microns), 35,000 nm, 30,000 nm, 15,000 nm, 10,000 nm, or 5,000 nm.

In some embodiments, Sa of the microstructured surface is at least 2 or 3 times the Sa of a smooth surface. In other embodiments, Sa of the microstructured surface is at least 4, 5, 6, 7, 8, 9, or 10 times the Sa of a smooth surface. In other embodiments, Sa of the microstructured surface is at least 15, 20, 25, 30, 35, 40, 45, 50 times the Sa of a smooth surface. In other embodiments, Sa of the microstructured surface is at least 100, 200, 300, 400, 500, 600, 700, 800, 900, or 1000 times the Sa of a smooth surface.

### The Root Mean Square (RMS) Parameter Sq, is Defined as:

$${S}_{q} = \sqrt{\frac{1}{MN} {\sum }_{k = 0}^{M - 1} {\sum }_{l = 0}^{N - 1} {[ z ( {x}_{k} , {y}_{l} ) ]}^{2}}$$

where M and N are the number of data points X and Y.

Although the Sq values are slightly higher than the Sa values, the Sq values also fall within the same ranges just described for the Sa values.

### The Surface Bearing Index, Sbi, is Defined as:

$${S}_{bi} = \frac{{S}_{q}}{{Z}_{0.05}} ,$$

wherein Z_{0.05} is the surface height at 5% bearing area.

### The Valley Fluid Retention Index, Svi, is Defined as:

$${S}_{vi} = \frac{{V}_{v} ( {h}_{0.8} )}{( M - 1 ) ( N - 1 ) δ x δ y} / {S}_{q} ,$$

wherein Vv(h0.80) is the void volume at valley zone within 80-100% bearing area.

As noted in the S Parameters table above, the Sbi/Svi ratio of the comparative smooth samples were 1 and 3. The microstructured surfaces having improved microorganism removal after cleaning had a Sbi/Svi ratio of greater than 3. The microstructured surfaces have a Sbi/Svi ratio of at least 4, 5, or 6. In some embodiments, the microstructured surfaces having improved microorganism removal after cleaning had a Sbi/Svi ratio of at least 7, 8, 9, or 10. In some embodiments, the microstructured surfaces having improved microorganism removal after cleaning had a Sbi/Svi ratio of at least 15, 20, 25, 30, 35, 40 or 45. The microstructured surfaces having improved microorganism removal after cleaning had a Sbi/Svi ratio of less than the comparative square wave microstructured surfaces. Thus, the microstructured surfaces having improved microorganism removal after cleaning had a Sbi/Svi ratio of less than 90, 85, 80, 75, 70 or 65. In some embodiments, the microstructured surfaces having improved microorganism removal after cleaning had a Sbi/Svi ratio of less than 60, 55, 50, 45, 40, 35, 30, 25, 20, or 10.

Topography maps can also be used to measure other features of the microstructured surface. For example, the peak height (especially of a repeating peak of the same height) can be determined from the height histogram function of the software. To calculate the percentage of “flat regions” of a square wave film, the “flat regions” can be identified using SPIP's Particle Pore Analysis feature, which identifies certain shapes (in this case, the “flat tops” of the microstructured square wave film.

Referring now to FIG. 8B, a generalized schematic perspective view is provided of a tool 820 comprising a plurality of protrusions, namely a tool 820 having a shape of a dental arch in which numerous protrusions are present; e.g., each tooth 825, as well as the overall curved arch shape. Moreover, the tool 820 further includes one or more areas having a concave shape e.g., concavities 827 of some of the teeth. The presence of a concavity will result in an outwardly curved inverse shape on the thermoformed article. This is a case of a tool having a plurality of protrusions and a plurality of concavities. Any tool according to the present disclosure may include one or more protrusions, one or more concavities, or at least one of each of a protrusion and a concavity.

In methods of the present disclosure, a microstructured film is disposed on some or all of a tool, including on one or more protrusions or one or more concavities. For example, FIG. 8C is a photograph of the polyvinyl chloride microstructured (e.g., tooling) film of FIG. 8A disposed on a dental arch 820, with the microstructured surface 810 on the exterior of the film 800c. As mentioned above, an advantage of this configuration is that a standard microstructured surface can be imparted to a custom tool. In this case, the microstructured film 800c has been thermoformed onto the dental arch 820 to conform to protrusions and concavities of the dental arch 820. Depending on the specific application, the microstructured film may be disposed on 50% or greater of a thermoforming surface of the tool, such as 55%, 60%, 65%, 70%, 75%, 80%, 85%, 90%, or 95% or greater of a thermoforming surface of the tool; and 100% or less, 98%, 93%, 88%, 83%, 78%, 73%, 68%, 63%, 58%, or 53% or less of a thermoforming surface of the tool.

FIG. 8D is a photograph of an exemplary article 830 thermoformed onto the microstructured (e.g., tooling) film (not visible under the article 830) and dental arch 820 of FIG. 8C. In this example, the thermoplastic polypropylene polymer is shaped to comprise more than one curve that comprises a microstructured surface, namely each curve that is an inverse of a protruding portion of a tooth, a concavity of a tooth, and the curve of the dental arch. As such, depending on the specific microstructured article being formed, the thermoplastic polymer may suitably be shaped to comprise a second curve that comprises a microstructured surface, a third curve, a fourth curve, etc.

By thermoforming a thermoplastic polymer onto the microstructured film (e.g., 800c) present on the dental arch 820, an exemplary microstructured article 830 was formed having a microstructured surface on an interior portion of (at least one) curve of the microstructured article 830. For instance, FIG. 8E is an optical micrograph image of an interior surface of the exemplary article 830 of FIG. 8D, wherein the surface is a microstructured surface 840 located on a curve of the microstructured article 830. Similarly, FIG. 8F is an optical micrograph image of a larger portion of the interior surface of the exemplary article 830 of FIG. 8D, wherein the surface is a microstructured surface 840 located on a plurality of curves 835 of the microstructured article 830. While in this example a portion of a curve comprising the microstructured surface comprises an interior portion of the article, in certain articles according to the present disclosure a portion of a curve comprising the microstructured surface comprises an exterior portion of the article (e.g., a handle of a utensil or tool, a vehicle steering wheel, etc.).

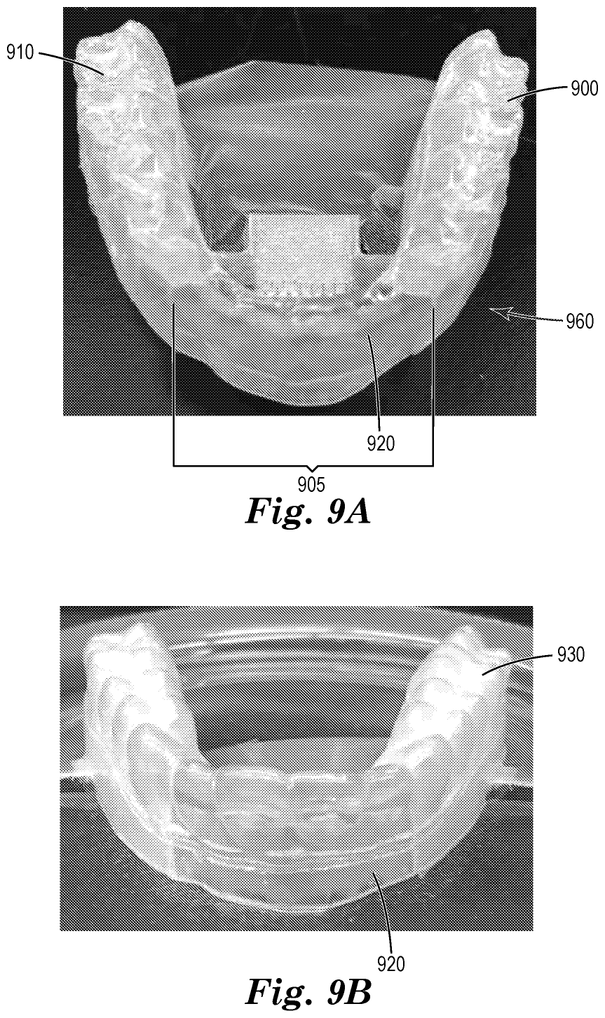

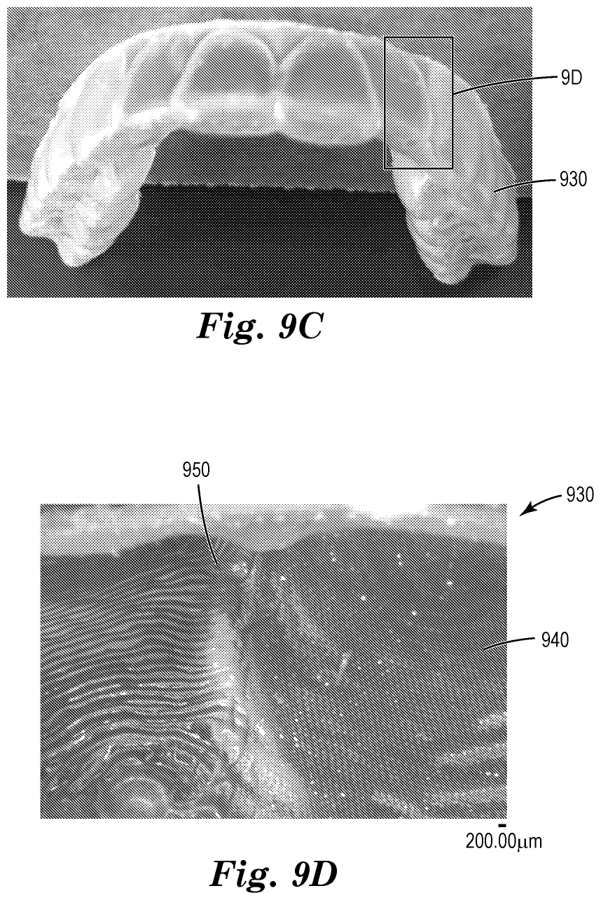

An advantage of adding a microstructured film to a tool having one or more protrusions and/or concavities is that it is a straightforward option to dispose the microstructured film on only select portions of the tool. For instance, FIG. 9A is a photograph of a polyvinyl chloride microstructured film 900 disposed on a dental arch, in which a portion of the microstructured (e.g., tooling) film 900 has been removed in the incisor area 905 of the dental arch 920. The microstructured surface 910 is present on the exterior of the film 900. Thus, a portion of the microstructured film may optionally be removed from the thermoforming surface of the tool prior to step c). Including a microstructured film on only a portion of a thermoforming surface of the tool (i.e., less than the full surface) of a tool can be useful when it is desired to provide a first coefficient of friction by the interior microstructured surface of the curve of that is different (i.e., either higher or lower) than a second coefficient of friction of a curve of the article that lacks the microstructured surface. Accordingly, in select embodiments, the thermoplastic polymer of an exemplary microstructured article is shaped to comprise a second curve that lacks a microstructured surface.

FIG. 9B is a photograph of an exemplary article 930 thermoformed onto the microstructured film 900 and dental arch 920 of FIG. 9A. The polypropylene microstructured article 930 covers both portions of the dental arch 920 where the microstructured (e.g., tooling) film 900 was disposed and portions in the incisor area 905 where the microstructured film 900 had been removed. In such embodiments, a geometry of a tool can advantageously be configured to be smaller (e.g., compensated) in a location where the microstructured film is disposed than in a location where the microstructured film is not disposed, such that the resulting microstructured article has an overall desired size that is not significantly affected by where the microstructured film is located on the tool. FIG. 9C is a photograph of the exemplary article 930 of FIG. 9B after removal of the article 930 from the dental arch 920. In general, the front (e.g., incisor) area of the tray article 930, which lacks the microstructured surface on its interior surface, has a more transparent appearance than the rest of the interior surfaces of the tray article 930. The box 9D indicates a portion of the microstructured article 930 shown in FIG. 9D. In particular, FIG. 9D is an optical micrograph image of a portion of the interior surface of the exemplary article 930 showing differentially microstructured areas between the location of the microstructured film and where a portion of the microstructured film had been removed from the dental arch. The microstructured surface 940 is present where the thermoplastic polymer was thermoformed over the microstructured film 900 and a surface 950 lacking utilitarian discontinuities is present where the thermoplastic polymer was thermoformed directly on the tool 920. In this case, the tool 920 was formed by an additive manufacturing method, and the surface 950 has a surface roughness imparted by the variations in surface caused by limitations in the resolution of the particular additive manufacturing method.

In a third aspect, a tooling article is provided. The tooling article comprises:
a) a tool shaped to comprise at least one of a protrusion or a concavity; and
b) a microstructured film disposed on at least a portion of the tool including the protrusion and/or the concavity, wherein the microstructured film comprises peak structures and adjacent valleys, wherein the valleys have a maximum width ranging from 1 micron to 250 microns and the peak structures have a side wall angle of greater than 10 degrees.

FIGS. 8C and 9A a microstructured tooling film disposed on a dental arch. As mentioned above, FIG. 8C is a photograph of the polyvinyl chloride microstructured (e.g., tooling) film of FIG. 8A disposed on a dental arch 820, with the microstructured surface 810 on the exterior of the film 800c. In this case, the microstructured film 800c has been thermoformed onto the dental arch 820 to conform to protrusions and concavities of the dental arch 820. As such, an exemplary tooling article 860 comprises a tool (e.g., having a shape of a dental arch) 820 shaped to comprise at least one of a protrusion or a concavity, and a microstructured film 800c disposed on at least a portion of the tool 820 including the protrusion and/or the concavity, wherein the microstructured film comprises peak structures and adjacent valleys 810, wherein the valleys have a maximum width ranging from 1 micron to 250 microns and the peak structures have a side wall angle of greater than 10 degrees. In certain such embodiments, the microstructured film 800c is disposed on 90% or greater of a thermoforming surface of the tool 820.

Further as mentioned above, FIG. 9A is a photograph of a polyvinyl chloride microstructured film 900 disposed on a dental arch, in which a portion of the microstructured (e.g., tooling) film 900 has been removed in the incisor area 905 of the dental arch 920. The microstructured surface 910 is present on the exterior of the film 900. Similar to FIG. 8C, FIG. 9A shows an exemplary tooling article 960 comprising a tool (e.g., having a shape of a dental arch) 920 shaped to comprise at least one of a protrusion or a concavity, and a microstructured film 900 disposed on at least a portion of the tool 920 including the protrusion and/or the concavity, wherein the microstructured film comprises peak structures and adjacent valleys 910, wherein the valleys have a maximum width ranging from 1 micron to 250 microns and the peak structures have a side wall angle of greater than 10 degrees. In such an embodiment, the microstructured film 900 is disposed on only a portion of a thermoforming surface of the tool 920.

### Method of Forming a Microstructured Film

The microstructured surface of the microstructured film can be prepared by various microreplication techniques such as coating, injection molding, embossing, laser etching, and extrusion. For example, microstructuring of the (e.g., engineered) film surface can be achieved by at least one of (1) casting a molten thermoplastic using a tool having a microstructured pattern, (2) coating of a fluid onto a tool having a microstructured pattern, solidifying the fluid, and removing the resulting film, (3) passing a thermoplastic film through a nip roll to compress against a tool having a microstructured pattern (i.e., embossing), and/or (4) contacting a solution or dispersion of a polymer in a volatile solvent to a tool having a microstructured pattern and removing the solvent, e.g., by evaporation. The tool can be metallic, such as nickel, nickel-plated copper or brass, or can be a thermoplastic material that is stable under the process conditions, and that preferably has a surface energy that allows clean removal of the polymerized material from the tool. It is to be understood that the microstructured film should comprise a material that will not melt or otherwise deform during the thermoforming process of forming the article such that the utilitarian discontinuities of the microstructured surface of the film maintain their shapes and impart the inverse of their shapes to a surface of the final article.

A tool used for preparing the microstructured film can be formed using any of a number of techniques known to those skilled in the art, selected depending in part upon the tool material and features of the desired topography. Illustrative techniques include etching (e.g., chemical etching, mechanical etching, or other ablative means such as laser ablation or reactive ion etching, etc., and combinations thereof), photolithography, stereolithography, micromachining, knurling (e.g., cutting knurling or acid enhanced knurling), scoring, cutting, etc., or combinations thereof. In some embodiments, the tool is a metal tool. The tool may further comprise a diamond like glass layer, such as described in WO 2009/032815 (David).

Additional information regarding materials and various processes for forming the microstructured tool surface can be found, for example, in PCT Publication No. WO 2007/070310 and US Publication No. US 2007/0134784 (Halverson et al.); US Publication No. US 2003/0235677 (Hanschen et al.); PCT Publication No. WO 2004/000569 (Graham et al.); U.S. Pat. No. 6,386,699 (Ylitalo et al.); US Publication No. US 2002/0128578 (Johnston et al.) and U.S. Pat. Nos. 6,420,622, 6,867,342, and 7,223,364 (Johnston et al.); and U.S. Pat. No. 7,309,519 (Scholz et al.) Such methods may be utilized to form a thermoformable microstructured base member (e.g., sheet or plate), which can then be thermoformed onto a tool comprising a protrusion and/or a concavity.

Useful (optional) base member materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, silicone and fluorinated films, and glass. Optionally, the base material can contain mixtures or combinations of these materials. In an embodiment, the base may be multi-layered or may contain a dispersed component suspended or dispersed in a continuous phase. An example of a useful PET films include photograde polyethylene terephthalate and MELINEX™ PET available from DuPont Films of Wilmington, Del. An example of a useful thermoformable material is polyethylene terephthalate (polyester with glycol) commercially available as VIVAK PETG. Such material is characterized by having a tensile strength ranging from 5000-10,000 psi (ASTM D638) and a flexural strength of 5,000 to 15,000 (ASTM D-790). Such material has a glass transition temperature of 178° F. (ASTM D-3418).

It also is possible and often preferable in order to maintain the fidelity of the microstructures to include a surface energy modifying compound in the composition used to form the microstructures. In some embodiments, the bloom additive may retard or prevent crystallization of the base composition. Suitable bloom additives may be found, for example, in International Publication No. WO 2009/152345 (Scholz et al.) and U.S. Pat. No. 7,879,746 (Klun et al.).

The materials for retroreflective sheeting and brightness enhancing films have been chosen based on the optical properties. Thus, the peak structures and adjacent valleys typically comprise a material having a refractive index of at least 1.50, 1.55, 1.60 or greater. Further, the transmission of visible light is typically greater than 85 or 90%. However, optical properties may not be of concern for many embodiments of the presently described films, methods, and articles. Thus, various other materials may be used having a lower refractive index including colored, light transmissive, and opaque.

As shown in FIG. 3, a continuous land layer 360 can be present between the bottom of the channels or valleys and the top surface 331 of (e.g., planar) base member 310. In some embodiments, such as when the microstructured surface is prepared from casting and curing a polymerizable resin composition, the thickness of the land layer is typically at least 0.1, 0.2, 0.3, 0.4, 0.5, 0.6, 0.7 0.8, 1, 2, 3, 4, or 5 microns ranging up to 50 microns. In some embodiments, the thickness of the land layer is no greater than 45, 40, 35, 30, 25, 20, 15, 10, 9, 8, 7, 6, 5, 4, 3, 2, 1, 0.9, 0.8, 0.7, 0.6, 0.5, 0.4, 0.3, or 0.2 microns. It was unexpectedly found that in some cases, a land thickness of 0.5 microns or less contributed to a microstructured film that is more resistant to macrocracks when thermoformed than the same microstructured film having a land thickness of greater than 0.5 microns.

In some embodiments, the microstructured surface (e.g., at least peak structures thereof) comprise an organic polymeric material with a glass transition temperature (as measured with Differential Scanning Calorimetry) of at least 25° C. In some embodiments, the organic polymeric material has a glass transition temperature of at least 30, 35, 40, 45, 50, 55 or 60° C. In some embodiments, the organic polymeric material has a glass transition temperature no greater than 100, 95, 90, 85, 80, or 75° C.

Referring again to FIGS. 2-4 and 6, the presently microstructured (e.g., tooling) film optionally comprises an (e.g., engineered) microstructured surface (200, 300, 400, 600) disposed on a base member (210, 310, 410, 610). In some cases, the base member is planar (e.g., parallel to reference plane 126). The thickness of the base member is typically at least 10, 15, 20, or 25 microns (1 mil) and typically no greater than 500 microns (20 mil) thickness. In some embodiments, the thickness of the base member is no greater than 400, 300, 200, or 100 microns. The width of the (e.g., film) base member may be is at least 30 inches (122 cm) and preferably at least 48 inches (76 cm). The base member may be continuous in its length for up to about 50 yards (45.5 m) to 100 yards (91 m) such that the microstructured film is provided in a conveniently handled roll-good. Alternatively, however, the (e.g., film) base member may be individual sheets or strips rather than as a roll-good.

Thermoformable microstructured base members typically having a thickness of at least 50, 100, 200, 300, 400, or 500 microns. Thermoformable microstructured base members may have thickness up to 3, 4, or 5 mm or greater. The base member can, in some implementations, include discrete pores and/or pores in communication. The thickness of the base member can vary depending on the use.

The organic polymeric materials of the base member can be the same organic polymeric materials previously described for the microstructured surface. In addition, fiber- and/or particle-reinforced polymers can also be used.

Non-limiting examples of suitable non-biodegradable polymers for base members include polyolefins (e.g., polyisobutylene copolymers), styrenic block copolymers (e.g., styrene-isobutylene-styrene block copolymers, such as styrene-isobutylene-styrene tert-block copolymers (SIBS); polyvinylpyrrolidone; polyvinyl alcohols; copolymers of vinyl monomers such as EVA; polyvinyl ethers; polyvinyl aromatics; polyethylene oxides; polyesters such as polyethylene terephthalate; polyamides; polyacrylamides; polyethers such as polyether sulfone; polyolefins such as polypropylene, polyethylene, and high or ultra high molecular weight polyethylene; polyurethanes; polycarbonates; silicones; siloxane polymers; natural based polymers such as optionally modified polysaccharides and proteins including, but not limited to, cellulosic polymers and cellulose esters such as cellulose acetate; and combinations comprising at least one of the foregoing polymers. Combinations may include miscible and immiscible blends as well as laminates.

The base member may be comprised of a biodegradable material. Non-limiting examples of suitable biodegradable polymers include polycarboxylic acid; polyanhydrides such as maleic anhydride polymers; polyorthoesters; poly-amino acids; polyethylene oxide; polyphosphazenes; polylactic acid, polyglycolic acid, and copolymers and mixtures thereof such as poly(L-lactic acid) (PLLA), poly(D,L,-lactide), poly(lactic acid-co-glycolic acid), and 50/50 weight ratio (D,L-lactide-co-glycolide); polydioxanone; polypropylene fumarate; polydepsipeptides; polycaprolactone and co-polymers and mixtures thereof such as poly(D,L-lactide-co-caprolactone) and polycaprolactone co-butylacrylate; polyhydroxybutyrate valerate and mixtures thereof, polycarbonates such as tyrosine-derived polycarbonates and arylates, polyiminocarbonates, and polydimethyltrimethylcarbonates; cyanoacrylate; calcium phosphates; polyglycosaminoglycans; macromolecules such as polysaccharides (including hyaluronic acid, cellulose, and hydroxypropylmethyl cellulose; gelatin; starches; dextrans; and alginates and derivatives thereof, proteins and polypeptides; and mixtures and copolymers of any of the foregoing. The biodegradable polymer can also be a surface erodible polymer such as polyhydroxybutyrate and its copolymers, polycaprolactone, polyanhydrides (both crystalline and amorphous), and maleic anhydride.

### Thermoplastic Polymers

Suitable thermoplastic polymers for use in making the microstructured article comprise a material that exhibits a draw down ratio of greater than 1.1, such as 1.2 or more, 1.3, 1.4, 1.5, 1.6, 1.7, 1.8, 1.9, 2.0 2.1, 2.2, or 2.3 or more; and 3.0 or less, 2.9, 2.8, 2.7, 2.6, 2.5, or 2.4 or less. Optionally, suitable thermoplastic polymers comprise a material that exhibits an elongation at break of 50% or greater, such as 55% or greater, 60%, 65%, 70%, 75%, 80%, 85%, 90%, 95%, or 100% or greater; and 400% or less. Elongation at break can be determined by ASTM D638-10, using test specimen Type V. It is preferred that the thermoplastic polymers possess the following properties: having thermal transition points such as glass transition temperatures between 70° C. and 140° C., an elongation at break greater than 100%, stain resistance, crack resistance, resistance to stress relaxation, and good optical clarity.

Some example suitable thermoplastic polymers include for instance and without limitation, a polypropylene, a polyester, a co-polyester, a polycarbonate, a thermoplastic polyurethane, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, silicone urethane copolymer, fluoropolymer, a thermoplastic elastomer, or any combination thereof. Polyurethanes may be formed from aromatic or aliphatic isocyanates combined with polyester or polyether polyols or a combination thereof. In some favored embodiments, the thermoplastic polymer comprises a polypropylene, such as under the trade designation “INVISACRYL C” from Great Lakes Dental Technologies (Tonawanda, NY).

Suitable polyesters include, but are not limited to, copolyesters available under the trade designation TRITAN from Eastman Chemical, Kingsport, TN, polyethylene terephthalate (PET), polyethylene terephthalate glycol (PETg), polycyclohexylenedimethylene terephthalate (PCT), polycyclohexylenedimethylene terephthalate glycol (PCTg), polycarbonate (PC), and mixtures and combinations thereof. Suitable PETg and PCTg resins can be obtained from various commercial suppliers such as, for example, Eastman Chemical, Kingspot, TN; SK Chemicals, Irvine, CA; Dow DuPont, Midiand, MI; Pacur, Oshkosh, WI; and Scheu Dental Tech, Iserlohn, Germany. For example, EASTAR GN071 PETg resins and PCTg VM318 resins from Eastman Chemical have been found to be suitable. Suitable polypropylene or polypropylene copolymer include, but are not limited to, Essix C+ from Dentsply Sirona, Charlotte, NC, and HardCast Material and INVISACRYL C from Great Lakes Dental Technologies, Tonawanda, NY. A suitable thermoplastic elastomer includes Hytrel from DuPont, Wilmington DE, Riteflex from Celanese, Irving, TX, Ecdel from Eastman Chemical Company, Kingsport, TN, Arnitel from DSM, Heerlen, Netherlands, Pelprene from Toyobo Co, Ltd, Osaka, Japan, and Elitel from Unitaka, Osaka, Japan.

### Optional Additives & Coatings

The thermoplastic polymer material of the microstructured article may contain other additives such as antimicrobial agents (including antiseptics and antibiotics), dyes, mold release agents, antioxidants, plasticizers, thermal and light stabilizers including ultraviolet (UV) absorbers, fillers, (e.g., for certain applications the fillers are radioopaque), pigments, and the like.

Suitable antimicrobials can be incorporated into or deposited onto the polymers. Suitable preferred antimicrobials include those described in US Publication Nos. 2005/0089539 and 2006/0051384 to Scholz et al. and US Publication Nos. 2006/0052452 and 2006/0051385 to Scholz. The microstructures of articles of the present disclosure also may be coated with antimicrobial coatings such as those disclosed in International Application No. PCT/US2011/37966 to Ali et al.

Typically, the microstuctured surface is not prepared from a low surface energy material (e.g., a fluoropolymer or PDMS) and does not comprise a low surface energy coating, a material or coating that on a flat surface has a receding contact angle with water of greater than 90, 95, 100, 105, or 110 degrees. In this embodiment, the low surface energy of the material is not contributing to the cleanability. Rather, the improvement in cleaning is attributed to the features of the microstructured surface. In this embodiment, the microstructured surface is prepared from a material such that a flat surface of the material typically has a receding contact angle with water of less than 90, 85, or 80 degrees.

Optionally, a low surface energy coating may be applied to the microstructures. Exemplary low surface energy coating materials that may be used include materials such as hexafluoropropylene oxide (HFPO), or organosilanes such as, alkylsilane, alkoxysilane, acrylsilanes, polyhedral oligomeric silsesquioxane (POSS) and fluorine-containing organosilanes, just to name a few. Examples of particular coatings known in the art may be found, e.g., in US Publication No. 2008/0090010 (Zhang et al.), and commonly owned publication, US Publication No. 2007/0298216 (Jing et al.). For embodiments, that include a coating is applied to the microstructures, it may be applied by any appropriate coating method, such as sputtering, vapor deposition, spin coating, dip coating, roll-to-roll coating, or any other number of suitable methods.

In some embodiments, the microstructures or microstructured surface may be modified such that the microstructured surface is more hydrophilic. The microstructured surface generally may be modified such that a flat organic polymer film surface of the same material as the modified microstructured surface exhibits an advancing or receding contact angle of 45 degrees or less with deionized water. In the absence of such modifications, a flat organic polymer film surface of the same material as the microstructured surface typically exhibits an advancing or receding contact angle of greater than 45, 50, 55, or 60 degrees with deionized water.

Any suitable known method may be utilized to achieve a hydrophilic microstructured surface. Surface treatments may be employed such as plasma treatment, vacuum deposition, polymerization of hydrophilic monomers, grafting hydrophilic moieties onto the film surface, corona or flame treatment, etc. For certain embodiments, the hydrophilic surface treatment comprises a zwitterionic silane, and for certain embodiments, the hydrophilic surface treatment comprises a non-zwitterionic silane. Non-zwitterionic silanes include a non-zwitterionic anionic silane, for instance.

In other embodiments, the hydrophilic surface treatment further comprises at least one silicate, for example and without limitation, comprising lithium silicate, sodium silicate, potassium silicate, silica, tetraethylorthosilicate, poly(diethoxysiloxane), or a combination thereof. One or more silicates may be mixed into a solution containing the hydrophilic silane compounds, for application to the microstructured surface.

### Articles

Since one useful object is to provide an article having a surface with increased microorganism (e.g., bacteria) removal when cleaned, the article is typically not a (e.g., sterile) medical article such as nasal gastric tubes, wound contact layers, blood stream catheters, stents, pacemaker shells, heart valves, orthopedic implants such as hips, knees, shoulders, etc., periodontal implants, dentures, dental crowns, contact lenses, intraocular lenses, soft tissue implants (breast implants, penile implants, facial and hand implants, etc.), surgical tools, sutures including degradable sutures, cochlear implants, tympanoplasty tubes, shunts including shunts for hydrocephalus, post-surgical drain tubes and drain devices, urinary catheters, endotracheal tubes, heart valves, wound dressings, other implantable devices, and other indwelling devices. The medical articles just described may be characterized as single use articles, i.e., the article is used once and then discarded. The above articles may also be characterized as single person (e.g., patient) articles. Thus, such articles are typically not cleaned (rather than sterilized) and reused with other patients.

In contrast, the articles and surfaces described herein include those where the microstructured surface is exposed to the surrounding (e.g., indoor or outdoor) environment and is subject to being touched or otherwise coming in contact with multiple people and/or animals, as well as other contaminants (e.g., dirt).

In some embodiments, the microstructured surface of the article, comes in direct (e.g., skin) contact with (e.g., multiple) people and/or animals during normal use of the article. In other embodiments, the microstructured surface may come is close proximity to (e.g., multiple) people/or animals in the absence of direct (e.g., skin) contact. However, since the microstructured surface comes in close proximity such article surfaces can easily be contaminated with microorganisms (e.g., bacteria) and are therefore cleaned to prevent the spreading of microorganisms to others.

Representative articles that would be cleaned during normal use and/or are amenable for use integrating the microstructured surface into a curved surface of the article include various interior or exterior surfaces or components of a medical article, a dental article, an orthodontic article, a vehicular article, an electronic article, a personal care article, a cleaning article, an athletic article, a food preparation article, a child care article, or an architectural article. More particularly, some examples of representative articles of these categories may include the following:
a) vehicular articles (e.g., automobile, bus, train, airplane, boat, ambulances, ships), such as head rests, dashboards, door panels, window shutter (e.g., of an airplane), gear shifter, seat belt buckle, instrument and button panels, arm rests, railings, luggage compartments, steering wheels, handlebars, etc.);
b) medical articles or dental articles including (e.g., non-sterile) surfaces of a medical, dental, or laboratory facility or medical, dental, or laboratory equipment (e.g., defibulators, ventilators and CPAPs (especially masks thereof), face shields, crutches, wheelchairs, bed rails, breast pump devices, IV pole and bags, dental tools (e.g., hand tools used during dental cleaning and restoration procedures), curing lights (e.g., for dental materials), exam tables, etc.;
c) orthodontic articles including aligners (e.g., clear tray aligners), retainers, night guards, splints, class II and class III correctors, sleep apnea devices, bite openers, bands, brackets, buccal tubes, cleats, buttons, other attachment devices, etc.;
d) electronic articles including housings and cases of electronic devices (e.g., phones, laptops, tablets, or computers) as well as keyboards, mouses, projectors, printers, remote control devices, locks, chargers (including cords & docking stations), fobs, video and arcade games, slot machines, automatic teller machines; and point of sale electronic devices such as credit card readers, keypads, stylists, cash registers, barcode scanner, payment kiosks, etc.;
e) personal care articles including toothbrushes, eye glass frames, shoes, clothing, handbags, etc.;
f) cleaning articles including vacuums, mops, scrub brushes, dusters, toilet bowl cleaners, plungers, brooms, etc.;
g) athletic articles including helmets, guards, balls and hand-held equipment for various sports including baseball, lacrosse, tennis, football, basketball, soccer, and golf, etc.;
h) food preparation articles appliances (e.g., microwaves, stoves, ovens, blenders, toasters, coffee makers, refrigerators), grills, utensils (e.g., especially handles thereof), condiment bottles, salt & pepper shakers, galleys, carts, cutting boards, lunch boxes, thermoses, tables and chairs (especially for public dining in restaurants, dorms, nursing homes, and prisons), etc.;
i) child care articles including toys, pacifiers, bottles, teethers, car seats, cribs, changing tables, playground equipment, etc.; and
j) architectural articles including railings, countertops, desktops, cabinets, lockers, window sills, electrical modulators (e.g. light switches, dimmers, and outlets), components of furniture (e.g., desks, tables, chairs, seats and armrests); handles (e.g. knob, pull, levers including locks) of articles including furniture, doors of buildings, turn styles, appliances, vehicles, shopping carts and baskets, surfaces and components of lavatories (e.g. sink, toilet surfaces (e.g. levers), drain caps, shower walls, bathtub, vanity, countertop), etc.

The microstructured surface is particularly advantageous for congregate living facilities such as military housing, prisons, dorms, nursing homes, apartments, hotels; public places such as offices, schools, arenas, casinos, bowling alleys, golf courses, arcades, gyms, salons, spas, shopping centers, airports, train stations; and public transportation.

In select cases, the article comprises an orthodontic article. Optionally, the microstructured surface of the orthodontic aligner provides a first coefficient of friction that is different than a second coefficient of friction of a curve of the orthodontic aligner that lacks the microstructured surface. For instance, when the coefficient of friction is lower, microstructures can be included in locations of the orthodontic article where the teeth don't need to be moved, for greater comfort when worn by a user. Referring to FIGS. 8A-8D, an example is provided where the incisors need to be moved and that portion of the aligner lacks the microstructured surface, whereas the remaining teeth do not require adjustment and the remaining areas of the aligner include a microstructured surface over most of the interior cavity.

The term “microorganism” is generally used to refer to any prokaryotic or eukaryotic microscopic organism, including without limitation, one or more of bacteria (e.g., motile or nonmotile, vegetative or dormant, Gram positive or Gram negative, planktonic or living in a biofilm), bacterial spores or endospores, algae, fungi (e.g., yeast, filamentous fungi, fungal spores), mycoplasmas, and protozoa, as well as combinations thereof. In some cases, the microorganisms of particular interest are those that are pathogenic, and the term “pathogen” is used to refer to any pathogenic microorganism. Examples of pathogens can include, but are not limited to, both Gram positive and Gram negative bacteria, fungi, and viruses including members of the family Enterobacteriaceae, or members of the family Micrococaceae, or the genera Staphylococcus spp., Streptococcus, spp., Pseudomonas spp., Acinetobacter spp., Enterococcus spp., Salmonella spp., Legionella spp., Shigella spp., Yersinia spp., Enterobacter spp., Escherichia spp., Bacillus spp., Listeria spp., Campylobacter spp., Acinetobacter spp., Vibrio spp., Clostridium spp., Klebsiella spp., Proteus spp. Aspergillus spp., Candida spp., and Corynebacterium spp. Particular examples of pathogens can include, but are not limited to, Escherichia coli including enterohemorrhagic E. coli e.g., serotype O157:H7, O129:H111; Pseudomonas aeruginosa; Bacillus cereus; Bacillus anthracis; Salmonella enteritidis; Salmonella enterica serotype Typhimurium; Listeria monocytogenes; Clostridium botulinum; Clostridium perfringens; Staphylococcus aureus; methicillin-resistant Staphylococcus aureus; carbapenem-resistant Enterobacteriaceae, Campylobacter jejuni; Yersinia enterocolitica; Vibrio vulnificus; Clostridium difficile; vancomycin-resistant Enterococcus; Klebsiella pneumonia; Proteus mirabilus and Enterobacter [Cronobacter] sakazakii.

### EXEMPLARY EMBODIMENTS

In a first embodiment, the present disclosure provides a microstructured article. The microstructured article comprises a thermoplastic polymer shaped to comprise a curve comprising a curvature radius of up to 20 mm. At least a portion of the curve comprises a microstructured surface of utilitarian discontinuities. The microstructured surface comprises peak structures and adjacent valleys, wherein the valleys have a maximum width ranging from 1 micron to 250 microns and the peak structures have a side wall angle of greater than 10 degrees. The peak structures and the curve are formed of a single piece of the thermoplastic polymer.

In a second embodiment, the present disclosure provides an article according to the first embodiment, wherein the microstructured surface is integral to the curve of the thermoplastic polymer.

In a third embodiment, the present disclosure provides an article according to the first embodiment or the second embodiment, wherein the thermoplastic polymer comprises a material that exhibits a draw down ratio of greater than 1.1.

In a fourth embodiment, the present disclosure provides an article according to any of the first through third embodiments, wherein the thermoplastic polymer comprises a material that exhibits an elongation at break of 50% or greater or 100% or greater.

In a fifth embodiment, the present disclosure provides an article according to any of the first through fourth embodiments, wherein the thermoplastic polymer comprises a polypropylene, a polyester, a co-polyester, a polycarbonate, a thermoplastic polyurethane, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, silicone urethane copolymer, fluoropolymer, a thermoplastic elastomer, or any combination thereof.

In a sixth embodiment, the present disclosure provides an article according to the fifth embodiment, wherein the thermoplastic polymer comprises a polypropylene.

In a seventh embodiment, the present disclosure provides an article according to any of the first through sixth embodiments, wherein the thermoplastic polymer is shaped to comprise a second curve that lacks the microstructured surface.

In an eighth embodiment, the present disclosure provides an article according to any of the first through sixth embodiments, wherein the thermoplastic polymer is shaped to comprise a second curve that comprises a microstructured surface.

In a ninth embodiment, the present disclosure provides an article according to any of the first through eighth embodiments, wherein the peak structures each have a height of 10 microns to 250 microns.

In a tenth embodiment, the present disclosure provides an article according to any of the first through ninth embodiments, wherein the article is a medical article, a dental article, an orthodontic article, a vehicular article, an electronic article, a personal care article, a cleaning article, an athletic article, a food preparation article, a child care article, or an architectural article.

In an eleventh embodiment, the present disclosure provides an article according to any of the tenth embodiment, wherein the article is an orthodontic aligner, an orthodontic retainer, or a night guard.

In a twelfth embodiment, the present disclosure provides an article according to the eleventh embodiment, wherein the microstructured surface of the orthodontic aligner provides a first coefficient of friction that is different than a second coefficient of friction of a curve of the orthodontic aligner that lacks the microstructured surface.

In a thirteenth embodiment, the present disclosure provides an article according to any of the first through twelfth embodiments, wherein the portion of the curve comprising the microstructured surface comprises an interior portion.

In a fourteenth embodiment, the present disclosure provides an article according to any of the first through twelfth embodiments, wherein the portion of the curve comprising the microstructured surface comprises an exterior portion.

In a fifteenth embodiment, the present disclosure provides an article according to any of the first through fourteenth embodiments, wherein the peak structures have a height ranging from 1 to 125 microns.

In a sixteenth embodiment, the present disclosure provides an article according to any of the first through fifteenth embodiments, wherein the curve comprises a minimum curvature radius of 0.6 mm.

In a seventeenth embodiment, the present disclosure provides a method of making a microstructured article. The method comprises a) obtaining a tool shaped to comprise at least one of a protrusion or a concavity; b) disposing a microstructured film on at least a portion of the tool including the protrusion and/or the concavity; and c) thermoforming a single piece of thermoplastic polymer onto the tool to form a microstructured article shaped to comprise a curve comprising a curvature radius of up to 20 mm. The curve is an inverse of the protrusion or the concavity of the tool and at least a portion of the curve comprises a microstructured surface of utilitarian discontinuities being an inverse of a surface of the microstructured film. The microstructured surface comprises peak structures and adjacent valleys. The valleys have a maximum width ranging from 1 micron to 250 microns and the peak structures have a side wall angle of greater than 10 degrees.

In an eighteenth embodiment, the present disclosure provides a method according to the seventeenth embodiment, when the microstructured film is attached to the thermoplastic polymer and steps b) and c) are performed at least partially simultaneously.

In a nineteenth embodiment, the present disclosure provides a method according to the eighteenth embodiment, wherein the microstructured film is thermoformed onto the tool simultaneously with step c).

In a twentieth embodiment, the present disclosure provides a method according to any of the seventeenth through nineteenth embodiments, wherein the microstructured film is disposed on only a portion of a thermoforming surface of the tool.

In a twenty-first embodiment, the present disclosure provides a method according to any of the seventeenth through twentieth embodiments, wherein the microstructured film is disposed on 90% or greater of a thermoforming surface of the tool.

In a twenty-second embodiment, the present disclosure provides a method according to the twenty-first embodiment, wherein a portion of the microstructured film is removed from the thermoforming surface of the tool prior to step c).

In a twenty-third embodiment, the present disclosure provides a method according to the twentieth embodiment or the twenty-second embodiment, wherein a geometry of the tool is configured to be smaller in a location where the microstructured film is disposed than in a location where the microstructured film is not disposed.

In a twenty-fourth embodiment, the present disclosure provides a method according to any of the seventeenth through twenty-third embodiments, wherein the tool is formed by additive manufacturing.

In a twenty-fifth embodiment, the present disclosure provides a method according to the twenty-fourth embodiment, wherein step a) comprises making the tool using an additive manufacturing process.

In a twenty-sixth embodiment, the present disclosure provides a method according to any of the seventeenth through twenty-fifth embodiments, wherein the microstructured film has an average thickness of 25 microns to 380 microns.

In a twenty-seventh embodiment, the present disclosure provides a method according to any of the seventeenth through twenty-sixth embodiments, wherein the microstructured film has a land thickness of less than 1 micron, less than 0.5 microns, or less than 0.3 microns.

In a twenty-eighth embodiment, the present disclosure provides a method according to any of the seventeenth through twenty-seventh embodiments, wherein the microstructured article is the microstructured article of any of the first through sixteenth embodiments.

In a twenty-ninth embodiment, the present disclosure provides a tooling article. The tooling article comprises a tool shaped to comprise at least one of a protrusion or a concavity and a microstructured film disposed on at least a portion of the tool including the protrusion and/or the concavity. The microstructured film comprises peak structures and adjacent valleys, wherein the valleys have a maximum width ranging from 1 micron to 250 microns and the peak structures have a side wall angle of greater than 10 degrees.

In a thirtieth embodiment, the present disclosure provides a tooling article according to the twenty-ninth embodiment, wherein the microstructured film is disposed on only a portion of a thermoforming surface of the tool.

In a thirty-first embodiment, the present disclosure provides a tooling article according to the twenty-ninth embodiment or the thirtieth embodiment, wherein the microstructured film is disposed on 90% or greater of a thermoforming surface of the tool.

In a thirty-second embodiment, the present disclosure provides a tooling article according to any of the twenty-ninth through thirty-first embodiments, wherein the tool has a shape of a dental arch.

### EXAMPLES

The following Examples are merely for illustrative purposes and are not meant to be overly limiting on the scope of the appended claims.

Unless otherwise noted or otherwise apparent from the context, all parts, percentages, ratios, and the like in the Examples and the rest of the specification are provided on the basis of weight. Solvents and other reagents used were obtained from Sigma-Aldrich Chemical Company (Milwaukee, WI) unless otherwise noted.

### Materials

10 mil (0.254 mm) PETG film (obtained under the trade designation “PACUR PETG” Copolyester Sheet from Pacur, LLC, Oshkosh, WI)

5 mil (0.127 mm) and 30 mil (0.762 mm) PETG films were made by extruding pellets of PETG (obtained under the trade designation “EASTAR GN071” from Eastman Chemicals, Kingsport, TN) to 5 mil and 30 mil thicknesses, respectively.

Polypropylene disc, 125 mm diameter, 1.02 mm thick (obtained under the trade designation “INVISACRYL C” from Great Lakes Dental Technologies (formerly Great Lakes Orthodontics), Tonawanda, NY)

PETG disc, 125 mm diameter, 0.75 mm thick (obtained under the trade designation “DURAN REF3413” from Scheu-Dental GmbH, Iserlohn, Germany)

20 mil (0.508 mm) Microstructured Matte Polycarbonate film, (obtained under the trade designation “LEXAN 8B35” from Sabic, Mt. Vernon, IN)

Adhesion promoter (obtained under the trade designation “3M TAPE PRIMER 94” from 3M, St. Paul, MN)

Aliphatic urethane diarylate oligomer (obtained under the trade designation “PHOTOMER 6210” from IGM Resins USA, Inc., Charlotte, NC)

1,6-Hexanediol diacrylate (HDDA), (obtained under the trade designation “SR238” from Sartomer USA (Arkema Group), Exton, PA)

Photoinitiator, 2,4,6-Trimethylbenzoyldiphenylphosphine oxide (obtained under the trade designation “LUCIRIN TPO” from BASF Corporation, Florham Park, NJ)

### Inspection Methods

The articles were visually inspected and examined with a digital microscope (obtained under the trade designation “KEYENCE VHX-1000” from Keyence Corporation of America, Itasca, IL).

### Sample Preparation Procedures

### Microstructured Metal Tool 1

A pyramidal microstructured metal tool which had a microstructure described in Example 3 of PCT Pat. Pub. No. 2021/033151 (Connell et al.), but with a peak height of 23 microns, was used to fabricate microstructured tooling films or discs.

### Microstructured Metal Tool 2

A pyramidal microstructured metal tool which had a microstructure described in Example 3 of PCT Pat. Pub. No. 2021/033151 A1 (Connell et al.) with a peak height of 9 microns was used to fabricate microstructure tooling films or discs.

### Procedure 1 Batch Coating and Method for Making Microstructured Tooling Films or Discs

A layer of an adhesion promoter (“3M TAPE PRIMER 94”) was applied to the surface of a film substrate, using a clean brush, for enhancing the adhesion of a coating resin system to the substrate. The primer was allowed to dry at room temperature for 5 minutes before applying a second coating layer to maximize adhesion. The resin system used to cast on the metal tool contained 75 parts oligomer (“PHOTOMER 6210”), 25 parts hexanediol diacrylate (“SR238”), and 0.5 parts of photoinitiator (“LUCIRIN TPO”). The materials were blended with a high-speed mixer, and then heated in an oven set at 160° F. (71° C.) for 24 hours. The compounded resin was subsequently cooled to room temperature. The resin was then applied between the microstructure of the tooling plate and the primed surface of the substrate to form a coating bank, and the assembly was pressed by hand with a rubber hand roller to spread the resin between the tooling plate and the substrate. The sample was cured through the substrate using UV light by passing the sample 2 times through a UV processor having two Hg vapor lamps (obtained under the trade designation model “QC 120233 AN” from RPC Industries, Plainfield, IL) at a rate of 50 feet/minute (15.2 meters/minute) under a nitrogen atmosphere. The microstructure-coated substrate was separated from the tooling plate by hand. A 125 mm diameter hollow punch was used to cut out individual discs from the microstructured tooling film.

### Procedure 2 Casting Coating and Method for Preparing Microstructured Films

The resin prepared in Procedure 1 was coated onto a film substrate using a slot die. The resin-coated film was brought into contact with a tooling having a microstructured surface using pressure provided by a rotating nip roll at a given line speed. While the resin was in contact with the tool, the resin was cured using a high intensity Fusion Systems “D” lamp (from Fusion UV Curing Systems, Rockville, MD) with UV-A (315-400 nm) in the range of 100-1000 mJ/cm².

### Procedure 3 for Thermoforming

To thermoform, a 125 mm diameter substrate was heated for a specific time and then pulled down over a rigid-polymer dental arch model on a pressure molding machine (obtained under the trade designation “BIOSTAR VI” from Scheu-Dental GmbH, Iserlohn, Germany). The specific heating times were set at 14 seconds, 20 seconds, 30 seconds, 45 seconds, and 70 seconds for 5 mil PETG, 10 mil PETG, 30 mil PETG, polycarbonate, and polypropylene, respectively. The BIOSTAR VI chamber behind the film was pressurized to 90 psi (0.62 megapascals) for 15 seconds of cooling time, after which the chamber was vented to ambient pressure and the formed article and arch model were removed from the instrument and cooled down to room temperature under ambient condition. The model with the thermoformed substrate was removed from the machine and excess film was trimmed using an ultrasonic cutter (obtained under the trade designation “SONIC-CUTTER NE80” from Nakanishi Incorporated, Kanuma City, Japan)

### Example 1

A PETG microstructured tooling film was prepared from the 10 mil (0.254 mm) PETG film (“PACUR PETG” Copolyester Sheet) according to Procedure 1 described above, using Microstructured Metal Tool 1 as the tooling plate, and punched into a 125 mm diameter disc. The disc was thermoformed in the pressure molding machine (“BIOSTAR VI”) onto a rigid-polymer dental arch model with its microstructured surface facing away from the dental arch model according to Procedure 3. A polypropylene disc (“INVISACRYL C”) was then thermoformed over the microstructured tooling film on the rigid-polymer dental arch model according to the thermoforming conditions of Procedure 3, to make a tray. After trimming with an ultrasonic cutter (“SONIC-CUTTER NE80”), the polypropylene tray was separated from the tooling film and the dental arch model by hand. The polypropylene tray had a uniform appearance and the inversed structure of the microstructured surface of the tooling film was evident, when examined by microscope, on the surface of the cavity side of the polypropylene tray.

### Example 2

A PETG microstructured tooling film was prepared from the 10 mil (0.254 mm) PETG film (“PACUR PETG” Copolyester Sheet) according to Procedure 1 described above, using Microstructured Metal Tool 1 as the tooling plate, and punched into a 125 mm diameter disc. A polypropylene (“INVISACRYL™ C”) disc was heated for 70 seconds in the pressure molding machine (“BIOSTAR VI”) and then laminated to the PETG tooling film with the microstructured surface of the PETG tooling film in contact with the polypropylene disc under a pressure of 90 psi (0.62 megapascals). The laminated substrate was then thermoformed according to the thermoforming conditions of Procedure 3 on to a rigid-polymer dental arch model with a heating time of 50 seconds, with the tooling film in contact with the dental arch model, to form a tray. After trimming with the ultrasonic cutter (“SONIC-CUTTER NE80”), the polypropylene tray was separated from the tooling film and the dental arch model by hand. The polypropylene tray had uniform appearance and the inversed structure of the microstructured surface of the tooling film was evident, when examined by microscope, on the surface of the cavity side of the polypropylene tray.

### Example 3

A PETG microstructured tooling film was prepared from the 10 mil (0.254 mm) PETG film (“PACUR PETG” Copolyester Sheet) according to Procedure 1 described above, using Microstructured Metal Tool 1 as the tooling plate, and punched into a 125 mm diameter disc. The disc was thermoformed in the pressure molding machine (“BIOSTAR VI”) on to a rigid-polymer dental arch model with its microstructured surface facing away from the dental arch model according to Procedure 3. The tooling film from lateral incisors to central incisors was removed carefully from the dental arch model with a razor blade. A polypropylene disc (“INVISACRYL C”) was then thermoformed over the microstructured tooling film on the rigid-polymer dental arch model by the thermoforming conditions of Procedure 3 to form a tray. After trimming with the ultrasonic cutter (“SONIC-CUTTER NE80”), the polypropylene tray was separated from the tooling film and the dental arch model by hand. The polypropylene tray had differential microstructured appearance and the inverted structure of the microstructured surface of the tooling film was only evident on the surface of the cavity side of the polypropylene tray by microscope for the section where tooling was kept on the dental arch model during the thermoforming operation for the polypropylene disc.

### Comparative Example 1

An extrusion replicated matte polycarbonate film (“LEXAN 8B35”) was punched into a 125 mm diameter disc. The disc was thermoformed in the pressure molding machine (“BIOSTAR VI”) to a microstructured tooling film by Procedure 3 and trimmed with the ultrasonic cutter (“SONIC-CUTTER NE80”). The tooling film had good clarity and the matte (microstructured) surface was observed to have been erased by the heating and forming process of the thermoforming operation.

### Comparative Example 2

A microstructured PETG disc was prepared by Procedure 1 described above, using Microstructured Metal Tool 1 as the tooling plate, by coating the microstructured layer on a PETG disc (“DURAN REF3413”). The microstructured PETG disc was thermoformed in the pressure molding machine (“BIOSTAR VI”) to a tray by the thermoforming conditions of Procedure 3 and trimmed with the ultrasonic cutter (“SONIC-CUTTER NE80”).

### Comparative Example 3

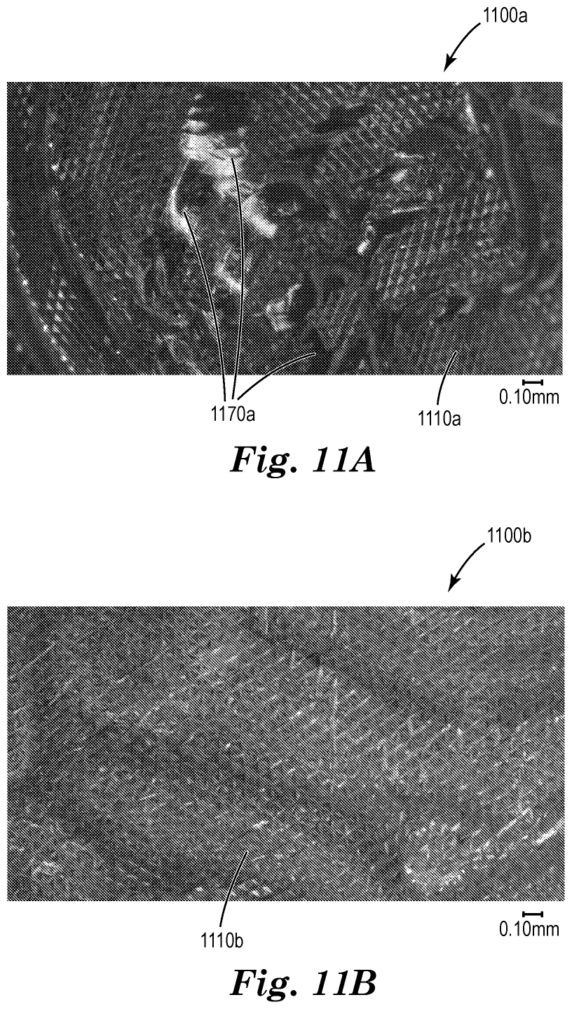

A microstructured PETG film was prepared by Procedure 2 described above, using Microstructured Metal Tool 1 as the tooling plate, from the 30 mil (0.762 mm) PETG film at a line speed of 25 fpm and 15 psi nip pressure and the shore hardness of the rubber nip roll was 95A. The microstructure coated film was punched into a 125 mm disc. The disc was thermoformed and trimmed to a microstructured tooling film by Procedure 3. Referring to FIG. 11A, the thermoformed microstructured tooling film 1100a had tiger stripe patterns on the microstructured surface 1110a, which are attributed to the macrocracks (e.g., 1170a) formed by deformation from the thermoforming operation.

### Example 4

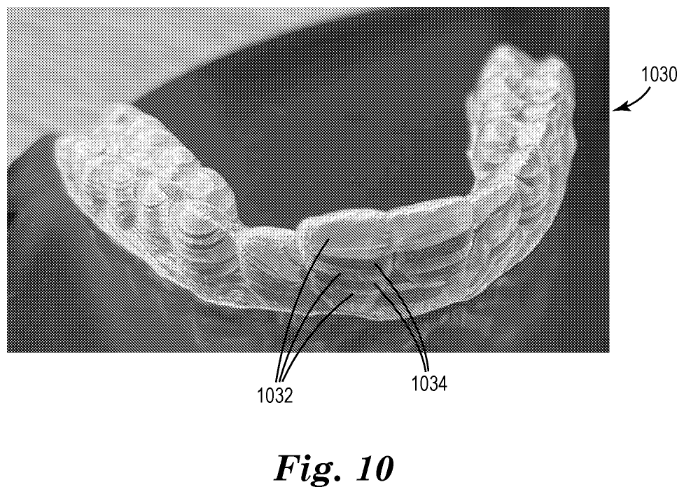

A microstructured PETG film was prepared by Procedure 2 described above, using Microstructured Metal Tool 1 as the tooling plate, from the 10 mil (0.254 mm) PETG film at a line speed of 25 feet per minute (fpm) and 15 psi nip pressure and the shore hardness of the rubber nip roll was 95A. The microstructure coated film was punched into a 125 mm disc. The disc was thermoformed and trimmed to a tooling film by Procedure 3. Referring to FIG. 10B, the thermoformed microstructured tooling film 1000b had a uniform appearance on its microstructured surface 1010b. The land thickness of coating below the microstructures was approximated by microscope less than 0.5 micron.

### Comparative Example 4

A microstructured PETG film was prepared by Procedure 2 described above, using Microstructured Metal Tool 1 as the tooling plate, from the 10 mil (0.254 mm) PETG film at a line speed of 15 fpm and 30 psi nip pressure and the shore hardness of the rubber nip roll was 90A. The land thickness of coating below the microstructure was approximated by microscope greater than 1.5 micron. The microstructure coated film was punched into a 125 mm disc. The disc was thermoformed and trimmed to a microstructured tooling film by Procedure 3. The thermoformed microstructured tooling film had tiger stripe patterns which are attributed to the macrocracks formed by deformation from the thermoforming operation. Referring to FIG. 10, the microstructured PETG tray 1030 had “tiger stripe” patterns which are attributed to the macrocracks formed by deformation from the thermoforming operation. For instance, a tray having a striped pattern is formed by the presence of alternating areas of the tray 1030 having thicker material 1032 (e.g., more opaque) and thinner material 1034 (e.g., more transparent).

### Comparative Example 5

A microstructured PETG film was prepared by Procedure 2 from the 10 mil (0.254 mm) PETG film from Microstructure Metal Tool 2 at a line speed of 25 fpm and 15 psi nip pressure and the shore hardness of the rubber nip roll was 95A. The microstructure coated film was punched into a 125 mm disc. The disc was thermoformed and trimmed to a microstructured tooling film by Procedure 3. The thermoformed microstructured tooling film had tiger stripe patterns which are attributed to the macrocracks formed by deformation from the thermoforming operation.

1. A microstructured article comprising a thermoplastic polymer shaped to comprise a curve comprising a curvature radius of up to 20 mm, wherein at least a portion of the curve comprises a microstructured surface of utilitarian discontinuities, wherein the microstructured surface comprises peak structures and adjacent valleys, wherein the valleys have a maximum width ranging from 1 micron to 250 microns and the peak structures have a side wall angle of greater than 10 degrees, and wherein the peak structures and the curve are formed of a single piece of the thermoplastic polymer.

2. The microstructured article of claim 1, wherein the microstructured surface is integral to the curve of the thermoplastic polymer.

3. The microstructured article of claim 1, wherein the thermoplastic polymer comprises a material that exhibits a draw down ratio of greater than 1.1.

4. The microstructured article of claim 1, wherein the thermoplastic polymer comprises a material that exhibits an elongation at break of 50% or greater or 100% or greater.

5. The microstructured article of claim 1, wherein the thermoplastic polymer comprises a polypropylene, a polyester, a co-polyester, a polycarbonate, a thermoplastic polyurethane, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, silicone urethane copolymer, fluoropolymer, a thermoplastic elastomer, or any combination thereof.

6. The microstructured article of claim 1, wherein the thermoplastic polymer is shaped to comprise a second curve that lacks the microstructured surface.

7. The microstructured article of claim 1, wherein the thermoplastic polymer is shaped to comprise a second curve that comprises a microstructured surface.

8. The microstructured article of claim 1, wherein the peak structures each have a height of 10 microns to 250 microns.

9. The microstructured article of claim 1, wherein the article is a medical article, a dental article, an orthodontic article, a vehicular article, an electronic article, a personal care article, a cleaning article, an athletic article, a food preparation article, a child care article, or an architectural article.

10. The microstructured article of claim 1, wherein the article is an orthodontic aligner, an orthodontic retainer, or a night guard.

11. The microstructured article of claim 10, wherein the microstructured surface of the orthodontic aligner provides a first coefficient of friction that is different than a second coefficient of friction of a curve of the orthodontic aligner that lacks the microstructured surface.

12. A method of making a microstructured article, the method comprising:
a) obtaining a tool shaped to comprise at least one of a protrusion or a concavity;
b) disposing a microstructured film on at least a portion of the tool including the protrusion and/or the concavity; and
c) thermoforming a single piece of thermoplastic polymer onto the tool to form a microstructured article shaped to comprise a curve comprising a curvature radius of up to 20 mm, the curve being an inverse of the protrusion or the concavity of the tool, wherein at least a portion of the curve comprises a microstructured surface of utilitarian discontinuities being an inverse of a surface of the microstructured film, wherein the microstructured surface comprises peak structures and adjacent valleys, wherein the valleys have a maximum width ranging from 1 micron to 250 microns and wherein the peak structures have a side wall angle of greater than 10 degrees.

13. The method of claim 12, when the microstructured film is attached to the thermoplastic polymer and steps b) and c) are performed at least partially simultaneously.

14. The method of claim 13, wherein the microstructured film is thermoformed onto the tool simultaneously with step c).

15. The method of claim 12, wherein the microstructured film is disposed on only a portion of a thermoforming surface of the tool.

16. The method of claim 12, wherein the microstructured film is disposed on 90% or greater of a thermoforming surface of the tool.

17. The method of claim 16, wherein a portion of the microstructured film is removed from the thermoforming surface of the tool prior to step c).

18. The method of claim 15, wherein a geometry of the tool is configured to be smaller in a location where the microstructured film is disposed than in a location where the microstructured film is not disposed.

19. The method of claim 18, wherein step a) comprises making the tool using an additive manufacturing process.

20. The method of claim 12, wherein the microstructured film has an average thickness of 25 microns to 380 microns.

21. The method of claim 12, wherein the microstructured film has a land thickness of less than 1 micron, less than 0.5 microns, or less than 0.3 microns.

22. A tooling article comprising:
a) a tool shaped to comprise at least one of a protrusion or a concavity; and
b) a microstructured film disposed on at least a portion of the tool including the protrusion and/or the concavity, wherein the microstructured film comprises peak structures and adjacent valleys, wherein the valleys have a maximum width ranging from 1 micron to 250 microns and the peak structures have a side wall angle of greater than 10 degrees.

23. The tooling article of claim 22, wherein the microstructured film is disposed on only a portion of a thermoforming surface of the tool.

24. The tooling article of claim 22, wherein the microstructured film is disposed on 90% or greater of a thermoforming surface of the tool.

25. The tooling article of claim 22, wherein the tool has a shape of a dental arch.
